(19) United States
(12) Patent Application Publication
(10) Pub. No.: US 2015/0323837 A1
(43) Pub. Date: Nov. 12, 2015

(54) LIQUID CRYSTAL DISPLAY DEVICE AND METHOD FOR FABTICATING THE SAME

(71) Applicant: JSR CORPORATION, Tokyo (JP)

(72) Inventors: YUUSUKE UESAKA, TOKYO (JP); JUNJI YOSHIZAWA, TOKYO (JP); YUKA SANO, TOKYO (JP)

(21) Appl. No.: 14/695,042

(22) Filed: Apr. 23, 2015

(30) Foreign Application Priority Data
May 9, 2014 (JP) 2014-098016

(51) Int. Cl. G02F 1/1337; G02F 1/1339

(52) U.S. Cl. CPC G02F 1/133711; G02F 1/1339; G02F 1/133723

(57) ABSTRACT

A liquid crystal display (LCD) device having a slim border, a high reliability and a better residual-image characteristic is described. The LCD device includes a pair of substrates, liquid crystal alignment films, a sealing part disposed on surfaces of the liquid crystal alignment films, and a liquid crystal layer containing liquid crystal molecules. The liquid crystal alignment films include a polymer (P) having in its main chain a moiety (1) or (2) described below. The moiety (1) is an alkylene chain having 3 or more carbon atoms. The moiety (2) has a structure obtained by inserting one or more of —CO—, —O—, —NH— and —Si(R¹)₂— between carbon atoms of an alkylene chain having 3 or more carbon atoms, wherein R¹ is a monovalent hydrocarbon group having 1 to 12 carbon atoms.

### CROSS-REFERENCE TO RELATED APPLICATION

This application claims the priority benefits of Japan application serial no. 2014-098016, filed on May 9, 2014. The entirety of the above-mentioned patent application is hereby incorporated by reference herein and made a part of this specification.

### BACKGROUND OF THE INVENTION

1. Field of the Invention

The invention relates to a liquid crystal display device and a method for fabricating the same, and particularly relates to a technique for narrowing the border of an LCD device.

2. Related Art

An LCD is fabricated by oppositely disposing a pair of substrates formed with liquid crystal alignment films, disposing a liquid crystal layer between the substrates, and bonding the substrates using a sealing material such as an epoxy resin. For a display panel of touch panel type typically used in smart phones and tablet personal computers, in order to increase the operable area of the touch panel as well as reduce the size of the LCD panel (device), there have been attempts to narrowing the panel border. A method proposed for this is to form the liquid crystal alignment films on the entire substrates, coat the sealing material on the liquid crystal alignment films and then bond the substrates (refer to Patent Document 1 or 2, for example).

### PRIOR-ART DOCUMENTS

### Patent Documents

Patent Document 1: JP 2013-109154 A

Patent Document 2: JP 4741870 B2

However, Inventors of this invention had discovered that as compared with an LCD device in which the sealing material is not disposed on liquid crystal alignment films, an LCD device formed with the sealing material being disposed on liquid crystal alignment films tends to have lower reliability and be easier to generate residual images. On the other hand, as the requirement on raising the performance of LCD device becomes higher, an LCD device having high display quality and having high reliability of withstanding even a long-term use is required.

### SUMMARY OF THE INVENTION

Accordingly, the invention provides an LCD having a slim border, a high reliability and a better residual-image characteristic, and a method for fabricating the LCD.

After active study, Inventors have discovered that the above issues can be addressed by using a polymer composition containing a polymer having a specific structure to form the liquid crystal alignment films, thus achieving this invention. Specifically, this invention provides the following LCD device and a method for fabricating the same.

The LCD device according to an aspect of this invention includes a pair of substrates facing each other, liquid crystal alignment films disposed on the opposite surfaces of the substrates respectively, a sealing part bonded between substrates, and a liquid crystal layer containing liquid crystal molecules that is disposed in the region defined by the substrates and the sealing part. The sealing part is disposed on surfaces of the liquid crystal alignment films. The liquid crystal alignment films include a polymer (P) having in its main chain a moiety (1) or (2) described below. The moiety (1) is an alkylene chain having 3 or more carbon atoms. The moiety (2) has a structure obtained by inserting at least one group selected from the group consisting of —CO—, —O—, —NH— and —Si(R¹)₂— between carbon atoms of an alkylene chain having 3 or more carbon atoms, wherein R¹ is a monovalent hydrocarbon group of 1 to 12 carbon atoms.

The method for fabricating the LCD device according to an aspect of this invention includes the steps below. Surfaces of respective substrates of a pair of substrates are coated with a polymer composition that contains a polymer (P) having in its main chain the moiety (1) or (2) to form coated films. The surface of the coated film on at least one of the substrates is coated with a sealing material. The substrates are arranged such that the coated films face each other as being separated by the sealing material to construct a liquid crystal cell.

Since the sealing part is disposed on the surfaces of the liquid crystal alignment films, the LCD device of this invention is allowed to have a slim border. Moreover, even though the sealing part is disposed on the surfaces of the liquid crystal alignment films, the reliability and the residual-image characteristic of the LCD device are still good by having the liquid crystal alignment films include the above polymer (P).

To make the aforementioned and other objects, features and advantages of this invention comprehensible, preferred embodiments accompanied with figures are described in detail below.

### BRIEF DESCRIPTION OF THE DRAWINGS

FIG. 1 schematically illustrates an LCD device of a first embodiment of this invention.

FIG. 2 schematically illustrates an LCD device of a second embodiment of this invention.

### DESCRIPTION OF THE EMBODIMENTS

### First Embodiment

### LCD Device

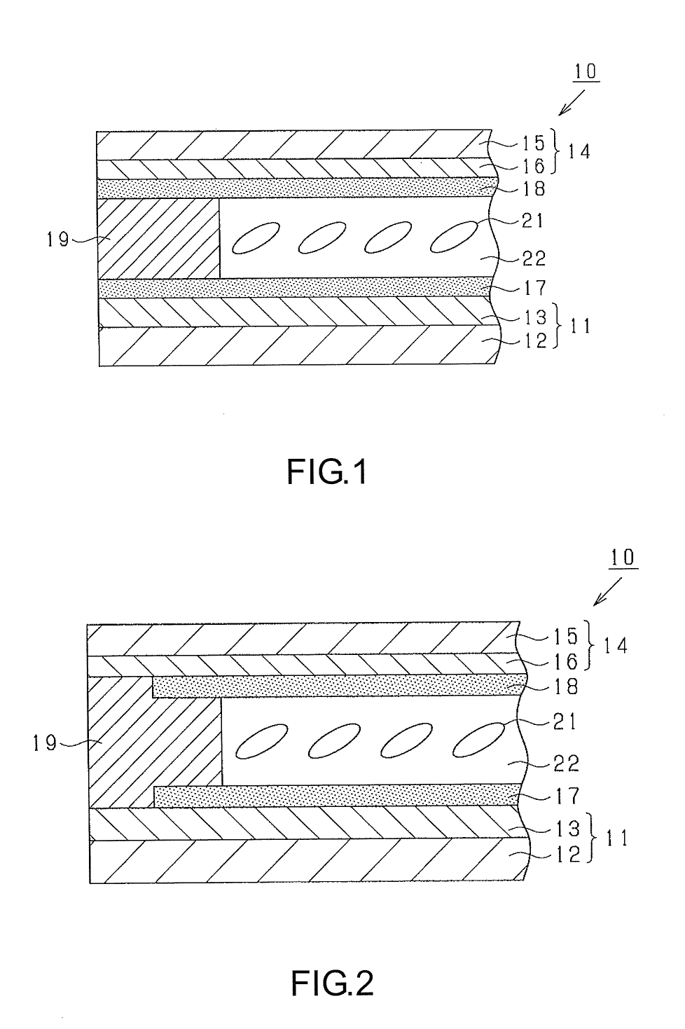

The LCD device of the first embodiment of this invention will be described in reference of FIG. 1 that schematically illustrates an LCD device 10 of the first embodiment. The LCD device 10 includes an array substrate 11, an opposite substrate 14 facing the array substrate 11, liquid crystal alignment films 17 and 18 respectively disposed on the opposite surfaces of the array substrate 11 and the opposite substrate 14, a sealing part 19 bonded between the two substrates, and a liquid crystal layer 22 disposed in the region defined by the two substrates 11 and 14 and the sealing part 19.

The array substrate 11 includes a transparent substrate 12. The transparent substrate 12 may be formed from, for example, glass such as float glass or soda-lime glass, or a plastic such as polyethylene terephthalate, polybutylene terephthalate, polyethersulfone, polycarbonate or poly(alicyclic olefin). In the array substrate 11, a TFT substrate 13 is disposed on the inside surface of the transparent substrate 12. The TFT substrate 13 includes a plurality of thin-film transistors (TFTs) and a plurality of pixel electrodes each driven by a TFT transistor. In this embodiment, an insulating layer is formed over the TFTs, and over the insulating layer, for example, a plurality of pixel electrodes are formed from a transparent conductive film facing the opposite substrate 14. The transparent conductive film may include a NESA film (trademark of PPG Industries, Inc.) including tin oxide (SnO₂), or an ITO film including indium oxide-tin oxide (In₂O₃—SnO₂), etc.

The opposite substrate 14 is disposed facing the array substrate 11 at a position apart by a predetermined distance, and constitutes the pair of substrates together with the array substrate 11. The opposite substrate 14 includes a transparent substrate 15, and an opposite electrode 16 that is disposed on the surface of the transparent substrate 15 facing the array substrate 11. As the transparent substrate 15 and the opposite electrode 16, a substrate formed using the same materials of the transparent substrate 12 and the pixel electrodes of the array substrate 11 can be used. Moreover, in this embodiment, the opposite electrode 16 serves as a common electrode for all the pixel electrodes.

The liquid crystal alignment films 17 and 18 are organic films including a polymer, and are formed using a polymer composition containing a polymer dissolved or dispersed in an organic solvent. In this embodiment, the liquid crystal alignment films 17 and 18 are formed on the entire surfaces of the array substrate 11 and the opposite substrate 14, respectively. The thickness of the liquid crystal alignment film 17 or 18 is preferably 0.001 to 1 μm, and more preferably 0.005 to 0.5 μm.

The sealing part 19 is for bonding the array substrate 11 and the opposite substrate 14 together and sealing liquid crystal molecules 21 between the array substrate 11 and the opposite substrate 14. The sealing part 19 is formed in a predetermined thickness using, for example, a UV-curable sealing material. As the sealing material, for example, an epoxy resin containing a curing agent and aluminum oxide balls as a spacer can be used. The sealing part 19 is disposed on the surfaces of the liquid crystal alignment film 17 or 18 along peripheral portions of the substrates 11 and 14, so that a sufficiently wide display area is ensured on the LCD device 10.

The liquid crystal layer 22 contains liquid crystal molecules 21 and is disposed adjacent to the liquid crystal alignment film 17 or 18 between the two substrates. Examples of the liquid crystal include a nematic liquid crystal and a smectic liquid crystal, wherein the nematic liquid crystal is preferred. The liquid crystal may be, for example, a Shiff base liquid crystal, an azoxy liquid crystal, a biphenyl liquid crystal, a phenylcyclohexane liquid crystal, an ester liquid crystal, a terphenyl liquid crystal, a biphenylcyclohexane liquid crystal, a pyrimidine liquid crystal, a dioxane liquid crystal, a bicyclooctane liquid crystal, or a cubane liquid crystal, etc. Moreover, these liquid crystals may also be used after being added with, e.g., a cholesteric liquid crystal such as cholesteryl chloride, cholesteryl nonaate or cholesteryl carbonate, a chiral agent sold under the trade name “C-15” or “CB-15” (made by Merck), or a ferroelectric liquid crystal such as p-decyloxybenzylidene-p-amine-2-methylbutyl cinnamate, etc.

Moreover, though not shown in the figure, polarizing plates are disposed on respective outside surfaces of the array substrate 11 and the opposite substrate 14. As the polarizing plate, a polarizing plate obtained by sandwiching between cellulose acetate protection films a so-called “H-film” including extension-aligned polyvinyl alcohol in which iodine is absorbed, or the H-film itself, can be used.

In the LCD device 10, the alignment state of the liquid crystal molecules 21 is changed by applying a voltage between a pair of electrodes including a pixel electrode and the common electrode. Thereby, light emitted from a light source such as a backlight is partially transmitted or blocked so that a display is performed.

<Polymer Composition>

The polymer composition for forming the liquid crystal alignment films 17 and 18 of the LCD device 10 with the sealing part 19 being disposed on the liquid crystal alignment films is described in details below. The polymer composition contains a polymer (P) having in its main chain a moiety (1) or (2) described below. The moiety (1) is an alkylene chain having 3 or more carbon atoms. The moiety (2) has a structure obtained by inserting at least one group selected from the group consisting of —CO—, —O—, —NH— and —Si(R¹)₂— between carbon atoms of an alkylene chain having 3 or more carbon atoms, wherein R¹ is a monovalent hydrocarbon group having 1 to 12 carbon atoms.

Moreover, the above moiety (1) or (2) is also called “the specific moiety,” hereinafter.

<Polymer (P)>

The above polymer (P) has the specific moiety in its main chain. In this specification, the “main chain” of a polymer means a backbone part including the longest chain of atoms in the polymer. The “backbone” part is allowed to contain a ring structure. In such cases, two or more atoms constituting the ring structure are respectively bonded with other atoms constituting the “backbone” part so that the entire ring structure exists in the main chain. Therefore, that the main chain has the specific moiety means that the moiety constitutes a part of the main chain. However, in the above polymer (P), the specific moiety may also be present in a part other than the main chain, for example, a side chain as a part branching from the backbone of the polymer.

The main chain of the polymer (P) is exemplified as a skeleton including a polyamic acid, a polyimide, a polyamic acid ester, a polyester or a polyamide, etc. As the polymer (P), one or more selected from the above polymers can be suitably used according to the use of the LCD device and so on. Such polymer (P) may be obtained by polymerizing a compound having the specific moiety as a monomer.

From the viewpoint of being good in various properties such as thermal resistance, mechanical strength, and affinity with the liquid crystal, the polymer (P) is preferably at least one selected from the group consisting of a polyamic acid, a polyimide and a polyamic acid ester among the above polymers.

<Polyamic Acid>

The polyamic acid having the above specific moiety in its main chain, which is called “the polyamic acid (P)” hereinafter, may possibly be obtained with the reaction of a tetracarboxylic dianhydride and a diamine. Specifically, the polyamic acid (P) may be synthesized with i) a method of containing a tetracarboxylic dianhydride having the specific moiety, which is called “specific tetracarboxylic dianhydride” hereinafter, in a monomer composition and performing polymerization, or ii) a method of containing a diamine having the specific moiety, which is called “specific diamine” hereinafter, in a monomer composition and performing polymerization, or iii) a method of containing the specific tetracarboxylic dianhydride and the specific diamine in a monomer composition and performing polymerization.

(Specific Tetracarboxylic Dianhydride)

Examples of the specific tetracarboxylic dianhydride include aliphatic tetracarboxylic dianhydrides, alicyclic tetracarboxylic dianhydrides, and aromatic tetracarboxylic dianhydrides, etc. Among them, the aromatic tetracarboxylic dianhydrides are preferred, of which specific examples include compounds represented by formula (t-1) below and so on.

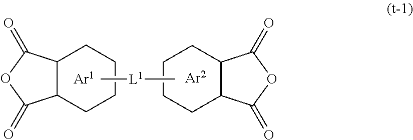

In formula (t-1), Ar¹ and Ar² are each independently a benzene ring or a naphthalene ring, and L¹ is a straight alkanediyl group having 3 or more carbon atoms, or is a divalent group obtained by inserting at least one group selected from the group consisting of —CO—, —O—, —NH— and —Si(R¹)₂— between carbon atoms of a straight alkanediyl group having 3 or more carbon atoms, wherein R¹ is a monovalent hydrocarbon group having 1 to 12 carbon atoms.

From the viewpoints of the transparency and the affinity with liquid crystal molecules, Ar¹ and Ar² in formula (t-1) are preferably benzene rings.

L¹ is the above specific moiety. The divalent group obtained by inserting at least one group selected from the group consisting of —CO—, —O—, —NH— and —Si(R¹)₂— (R¹ is a monovalent hydrocarbon group having 1 to 12 carbon atoms) between carbon atoms of a straight alkanediyl group having 3 or more carbon atoms, which is also called “alkylene group containing a heteroatom” hereinafter, may have a structure obtained by discontinuing a straight alkanediyl group having 3 or more carbon atoms with one of —CO—, —O—, —NH— and —Si(R¹)₂— or with a group obtained by combining two or more of the same, such as —COO—, —CONH— or —NH—CO—NH—, etc. The number of the groups discontinuing the straight alkanediyl group having 3 or more carbon atoms is not particularly limited. Moreover, as long as having 3 or more carbon atoms in total, the alkylene group containing a heteroatom does not necessarily have a straight alkanediyl group having 3 or more carbon atoms, and may alternatively have a plurality of straight alkanediyl groups having 2 or less carbon atoms.

R¹ in —Si(R¹)₂— is exemplified as a straight or branched alkyl group, a cycloalkyl group or an aryl group, etc., and is preferably methyl or ethyl. Moreover, a plurality of R¹ in the polymer (P) may be the same or different from each other.

From the viewpoint of the reliability of the LCD device, the functional group discontinuing the alkylene chain in the alkylene group containing a heteroatom is preferably at least one of —CO—, —O— and —COO—, and more preferably at least one of —O— and —COO—.

From the viewpoint of highly improving the reliability of the LCD device, in the alkanediyl group or the alkylene group containing a heteroatom as the group L¹, the total number of the carbon atoms constituting L¹ is preferably 3 to 12, and more preferably 3 to 10.

Among specific examples of L¹, examples of the straight alkanediyl group having 3 or more carbon atoms include 1,3-propanediyl, 1,4-butanediyl, 1,5-pentanediyl, 1,6-hexanediyl, 1,7-heptanediyl, 1,8-octanediyl, 1,9-nonanediyl, 1,10-decanediyl, 1,11-undecanediyl, 1,12-dodecanediyl, 1,13-tridecanediyl, 1,14-tetradecanediyl, 1,15-pentadecanediyl, and 1,20-icosanediyl, etc., and examples of the alkylene group containing a heteroatom include the following formulae (2-1) to (2-23).

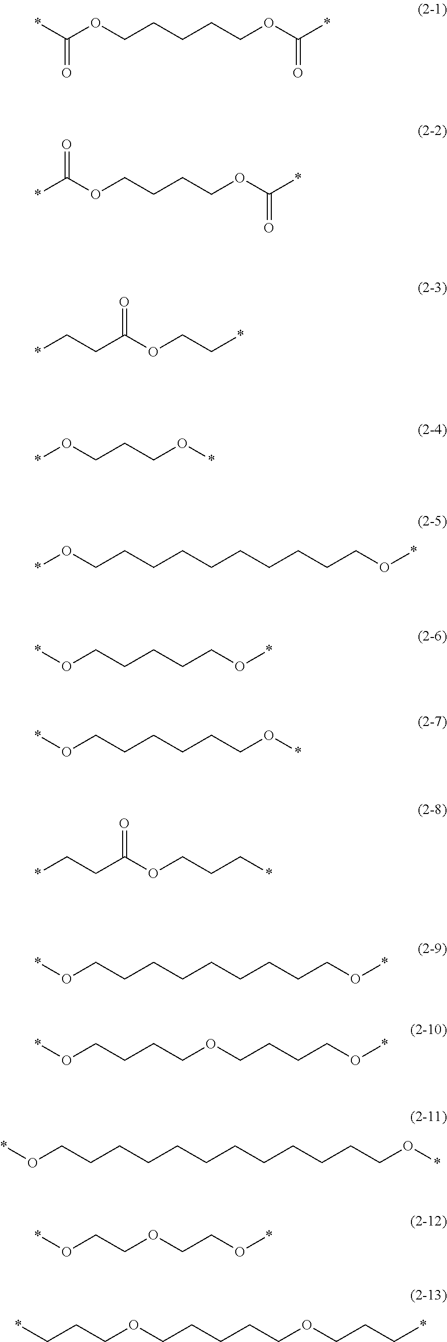

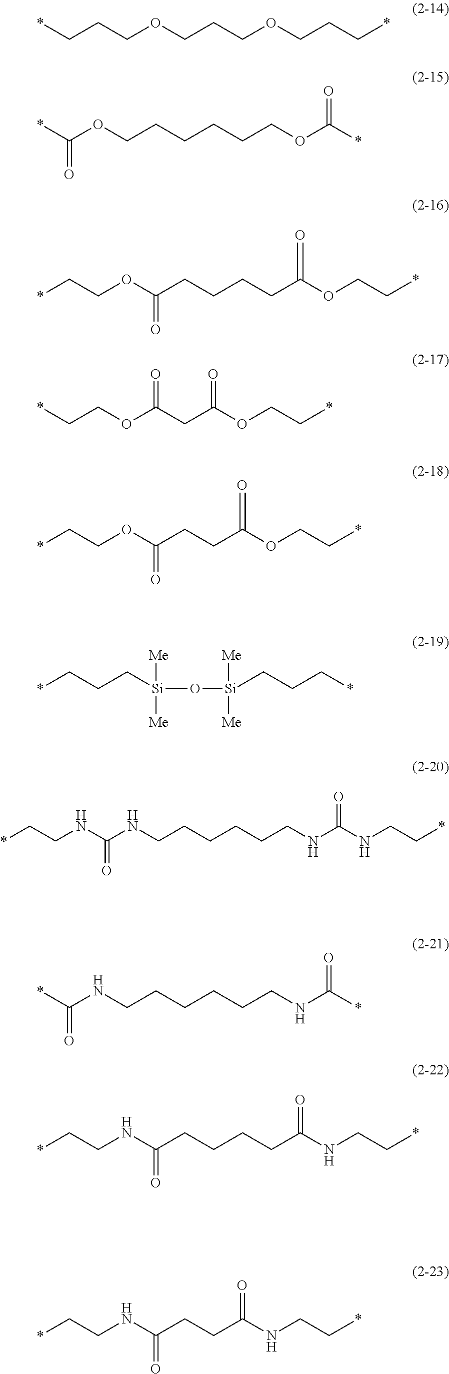

In these formulae, Me means methyl, and * indicates the bonding site.

Preferred specific examples of the specific tetracarboxylic dianhydride include the compounds represented by the following formulae (t-1-1) to (t-1-8), and so on.

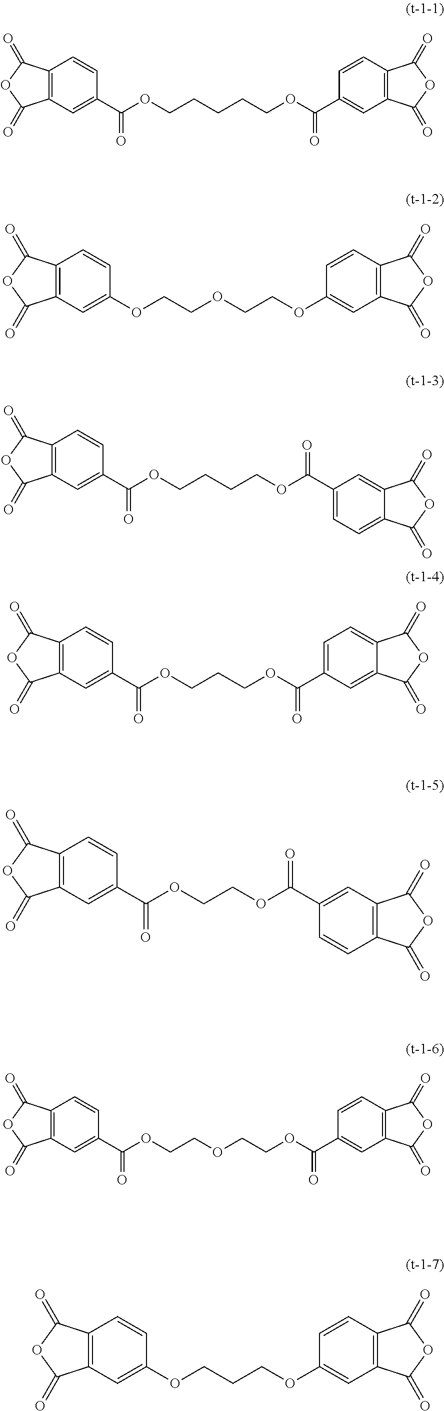

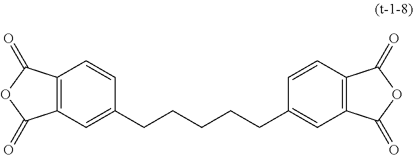 [SMILES: O=C1OC(=O)c2cc(CCCCCc3ccc4c(c3)C(=O)OC4=O)ccc21]

In a case where the specific tetracarboxylic dianhydride is used in the synthesis of the polyamic acid, relative to the total tetracarboxylic dianhydride, the proportion of the compound represented by the above formula (t-1) is preferably 1 mol % or more, more preferably 5 mol % or more, and even more preferably 10 mol % or more. The upper limit of the proportion of the compound of formula (t-1) is not particularly limited, and can be set according to the amount of the specific diamine used and so on. Moreover, as the specific tetracarboxylic dianhydride, one species can be used alone, or two or more species can be used in combination.

(Other Tetracarboxylic Dianhydrides)

In the synthesis of the polyamic acid, it is possible to use only the specific tetracarboxylic dianhydride, and is also possible to use the specific tetracarboxylic dianhydride and other tetracarboxylic dianhydride in combination. Examples of other tetracarboxylic dianhydride that can be used herein include an aliphatic tetracarboxylic dianhydride, an alicyclic tetracarboxylic dianhydride and an aromatic tetracarboxylic dianhydride, etc. Specific examples thereof are described below.

Examples of the aliphatic tetracarboxylic dianhydride include 1,2,3,4-butanetetracarboxylic dianhydride, etc.

Examples of the alicyclic tetracarboxylic dianhydride include 1,2,3,4-cyclobutanetetracarboxylic dianhydride, 2,3,5-tricarboxycyclopentylacetic acid dianhydride, 1,3,3a,4,5,9b-hexahydro-5-(tetrahydro-2,5-dioxo-3-furanyl)-naphtho[1,2-c]furan-1,3-dione, 1,3,3a,4,5,9b-hexahydro-8-methyl-5-(tetrahydro-2,5-dioxo-3-furanyl)naphtho[1,2-c]furan-1,3-dione, 3-oxabicyclo[3.2.1]octane-2,4-dione-6-spiro-3′-(tetrahydrofuran-2′,5′-dione), 5-(2,5-dioxotetrahydro-3-furanyl)-3-methyl-3-cyclohexane-1,2-dicarboxylic anhydride, 3,5,6-tricarboxy-2-carboxymethylnorbornane-2:3,5:6-dianhydride, 2,4,6,8-tetracarboxybicyclo[3.3.0]octane-2:4,6:8-dianhydride, 4,9-dioxatricyclo[5.3.1.0^{2,6}]undecane-3,5,8,10-tetraone, cyclohexanetetracarboxylic dianhydride, and the compound represented by the following formula (t-2-3).

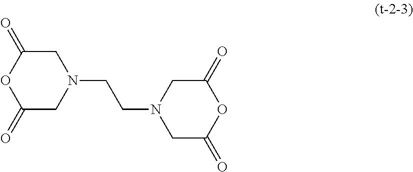 [SMILES: O=C1CN(CCN2CC(=O)OC(=O)C2)CC(=O)O1]

Examples of the aromatic tetracarboxylic dianhydride include pyromellitic dianhydride, 4,4′-(hexafluoroisopropylidene)diphthalic anhydride, the compounds of the following formulae (t-2-10) to (t-2-12), and so on.

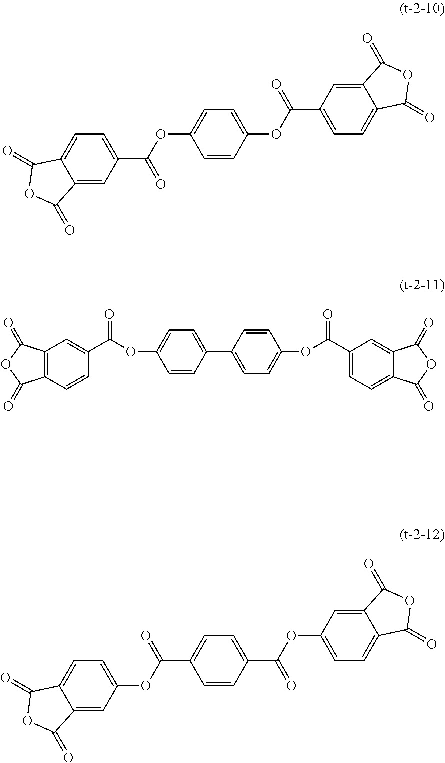 [SMILES: O=C(Oc1ccc(OC(=O)c2ccc3c(c2)C(=O)OC3=O)cc1)c1ccc2c(c1)C(=O)OC2=O ; O=C(Oc1ccc(-c2ccc(OC(=O)c3ccc4c(c3)C(=O)OC4=O)cc2)cc1)c1ccc2c(c1)C(=O)OC2=O ; O=C(Oc1ccc2c(c1)C(=O)OC2=O)c1ccc(C(=O)Oc2ccc3c(c2)C(=O)OC3=O)cc1]

In addition, the tetracarboxylic dianhydride described in JP 2010-97188 A can also be used. Such other tetracarboxylic dianhydrides can be used alone or in combination of two or more.

(Specific Diamine)

Examples of the specific diamine used in the synthesis of the polyamic acid (P) include aliphatic diamines, alicyclic diamines, aromatic diamines, and diaminoorganosiloxanes, etc. Specific examples of these diamines include: aliphatic diamines such as 1,3-propanediamine, tetramethylenediamine, pentamethylenediamine and hexamethylenediamine, etc.; aromatic diamines such as compounds represented by the following formula (d-1) in which Z¹ and Z² are each independently a single bond or a divalent organic group and L¹ is defined as in the case of the L¹ in the above formula (t-1):

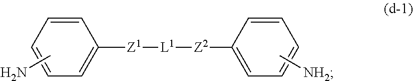

and diaminoorganosiloxanes such as 1,3-bis(3-aminopropyl)-tetramethyldisiloxane, and 3,3′-[(1,4-phenylenebis(dimethylsilanediyl)]bis(propane-1-amine), etc.

In the above formula, the divalent organic group as Z¹ or Z² can be exemplified as a divalent group having a ring structure, of which a preferred specific example is a group represented by the following formula (z-1).

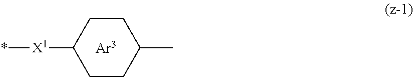

In formula (z-1), Ar³ is a benzene ring, a cyclohexane ring or a heterocycle, X¹ is a single bond, —CO—, —O—, —COO— or an alkanediyl group having 1 to 3 carbon atoms, and the *-marked bond is bonded to the aminophenyl group.

As the heterocycle Ar³ of formula (z-1), for example, a nitrogen-containing heterocycle such as a piperidine ring, a piperazine ring, a pyridine ring or a pyrimidine ring, etc. is preferred. Specific examples and preferred examples of the L¹ in formula (d-1) may refer to the description for the L¹ in the above formula (t-1).

Preferred specific examples of the compounds represented by the above formula (d-1) include the compounds of the following formulae (d-1-1), (d-1-2), (d-1-7) to (d-1-10) and (d-1-12) to (d-1-16), wherein in formulae (d-1-15), m is an integer of 3 to 20.

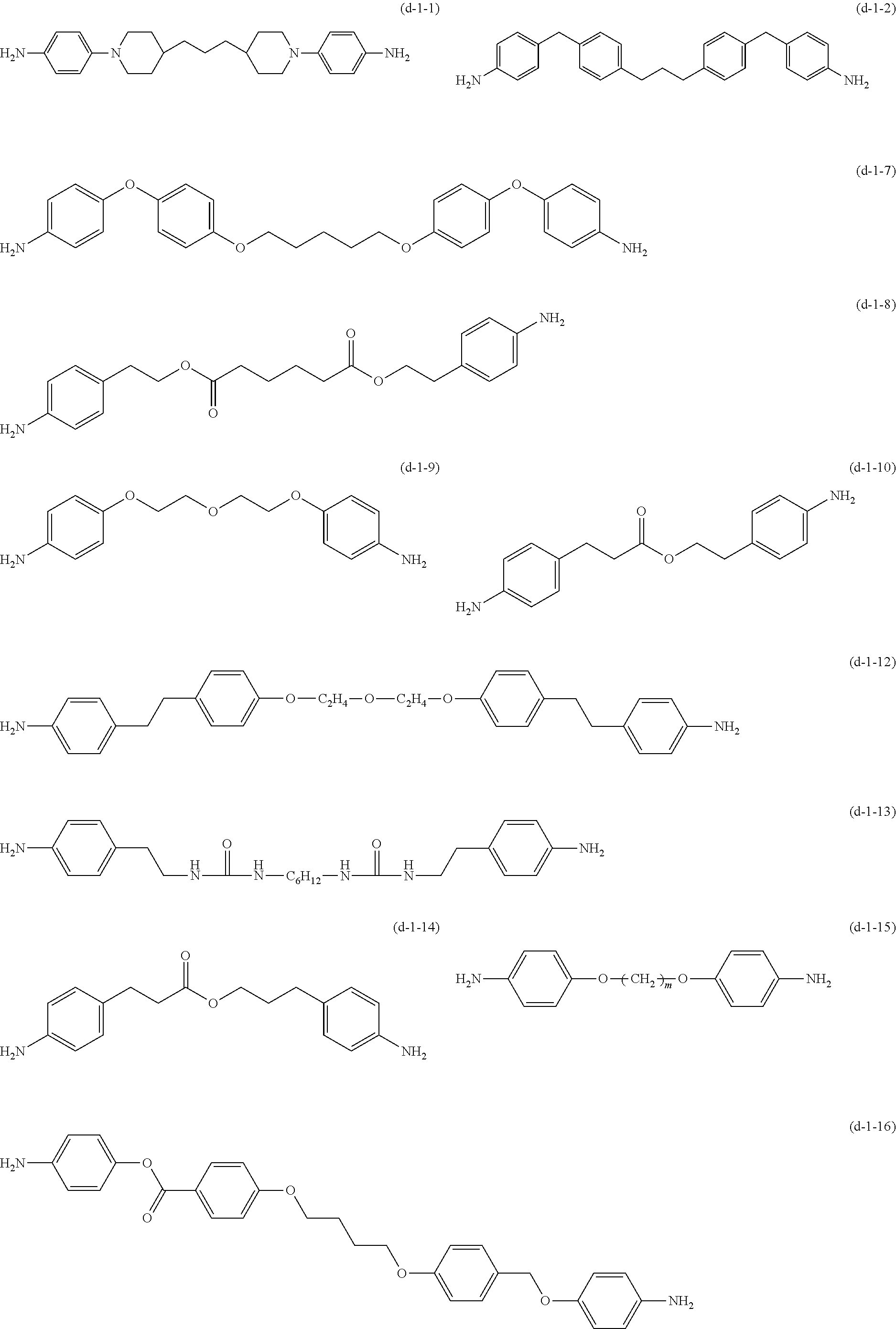

From the viewpoint of liquid crystal alignment effect, the specific diamine preferably contains an aromatic diamine. In a case where the specific diamine is used in the synthesis of the polyamic acid, relative to the total diamine, the proportion of the compound represented by the above formula (d-1) is preferably 1 mol % or more, more preferably 5 to 90 mol %, and even more preferably 10 to 80 mol %. Moreover, as the specific diamine, one species can be used alone, or two or more species can be used in combination.

(Other Diamine)

In the synthesis of the polyamic acid, it is possible to use only the specific diamine, and is also possible to use the specific diamine and other diamine in combination.

Other diamine that can be used herein may be exemplified as being classified into diamines having a functional group capable of inducing a pretilt angle (called “pretilt inducing group” hereinafter), and diamines having no pretilt inducing group.

The diamine having a pretilt inducing group is preferably an aromatic diamine, of which specific examples include dodecanoxy-2,4-diaminobenzene, tetradecanoxy-2,4-diaminobenzene, pentadecanoxy-2,4-diaminobenzene, hexadecanoxy-2,4-diaminobenzene, octadecanoxy-2,4-diaminobenzene, dodecanoxy-2,5-diaminobenzene, tetradecanoxy-2,5-diaminobenzene, pentadecanoxy-2,5-diaminobenzene, hexadecanoxy-2,5-diaminobenzene, octadecanoxy-2,5-diaminobenzene, cholesteryloxy-3,5-diaminobenzene, cholestanyloxy-2,4-diaminobenzene, cholesteryloxy-2,4-diaminobenzene, cholestanyl 3,5-diaminobenzoate, cholesteryl 3,5-diaminobenzoate, lanostanyl 3,5-diaminobenzoate, 3,6-bis(4-aminobenzoyloxy)cholestane, 3,6-bis(4-aminophenoxy) cholestane, 1,1-bis(4-((aminophenyl)methyl)phenyl)-4-butylcyclohexane, 1,1-bis(4-((aminophenyl)methyl)phenyl)-4-heptylcyclohexane, 1,1-bis(4-((aminophenoxy)methyl)phenyl)-4-heptylcyclohexane, 1,1-bis(4-((aminophenyl)methyl)phenyl)-4-(4-heptylcyclohexyl)cyclohexane, N-(2,4-diaminophenyl)-4-(4-heptylcyclohexyl)benzamide, and compounds represented by the following formula (D-1) in which X^{I} and X^{II} are each independently a single bond, —O—, —COO— or —OCO—, R^{I} is an alkanediyl group having 1 to 3 carbon atoms, R^{II} is a single bond or an alkanediyl group having 1 to 3 carbon atoms, a is 0 or 1, b is an integer of 0 to 2, c is an integer of 1 to 20, and d is 0 or 1, with a proviso that a and b are not simultaneously zero.

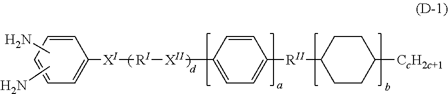

In addition, the diamine having a pretilt inducing group that is described in JP 2010-97188 A can also be used.

The divalent group —X^{I}—(R^{I}—X^{II})_{d}— in the above formula (D-1) is preferably an alkanediyl group having 1 to 3 carbon atoms, *—O—, *—COO— or *—O—C₂H₄—O—, wherein the *-marked bond is bonded to the diaminophenyl group. Specific examples of the group —C_{c}H_{2c+1} include methyl, ethyl, n-propyl, n-butyl, n-pentyl, n-hexyl, n-heptyl, n-octyl, n-nonyl, n-decyl, n-dodecyl, n-tridecyl, n-tetradecyl, n-pentadecyl, n-hexadecyl, n-heptadecyl, n-octadecyl, n-nonadecyl, and n-eicosyl, etc. The two amino groups in the diaminophenyl group are preferably at 2-position and 4-position, or 3-position and 5-position, relative to other groups.

Specific examples of the compounds represented by the above formula (D-1) include the compounds of the following formulae (D-1-1) to (D-1-5).

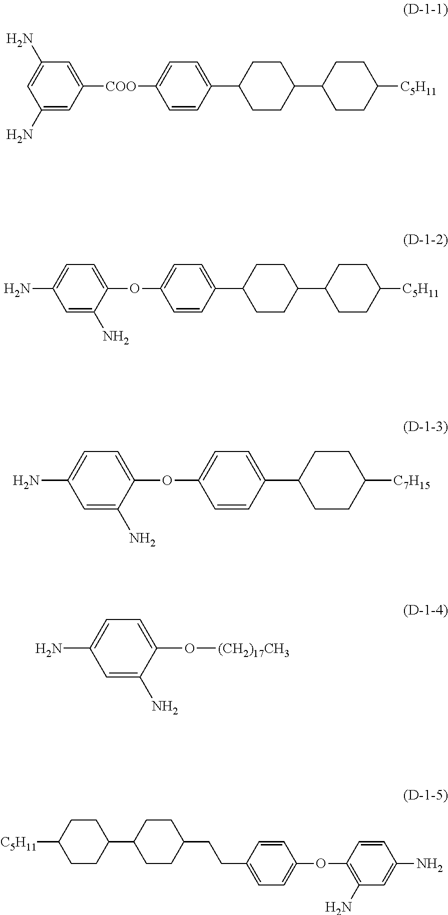

The diamine having no pretilt inducing group may be an aliphatic diamine, an alicyclic diamine, an aromatic diamine, or a diaminoorganosiloxane, etc. Specific examples of these diamines are described as follows. Examples of the aliphatic diamine include metaxylylenediamine, and 1,3-bis(aminomethyl)cyclohexane, etc. Examples of the alicyclic diamine include 1,4-diaminocyclohexane, and 4,4′-methylenebis(cyclohexylamine), etc.

Examples of the aromatic diamine include o-phenylenediamine, m-phenylenediamine, p-phenylenediamine, 4,4′-diaminodiphenylmethane, 4,4′-diaminodiphenylsulfide, 1,5-diaminonaphthalene, 2,2′-dimethyl-4,4′-diaminobiphenyl, 4,4′-diamino-2,2′-bis(trifluoromethyl)biphenyl, 2,7-diaminofluorene, 4,4′-diaminodiphenyl ether, 2,2-bis[4-(4-aminophenoxyl)phenyl]propane, 9,9-bis(4-aminophenyl)fluorine, 2,2-bis[4-(4-aminophenoxyl)phenyl]hexafluoropropane, 2,2-bis(4-aminophenyl)hexafluoropropane, 4,4′-(p-phenyleneisopropylidene)bisaniline, 4,4′-(m-phenyleneisopropylidene)bisaniline, 1,4-bis(4-aminophenoxy)benzene, 4,4′-bis(4-aminophenoxy)biphenyl, 2,6-diaminopyridine, 3,4-diaminopyridine, 2,4-diaminopyridine, 3,6-diaminoacridine, 3,6-diaminocarbazole, N-methyl-3,6-diaminocarbazole, N-methyl-3,6-diaminocarbazole, N-phenyl-3,6-diaminocarbazole, N,N′-bis(4-aminophenyl)benzidine, N,N′-bis(4-aminophenyl)-N,N′-dimethylbenzidine, 1,4-bis(4-aminophenyl)piperazine, 3,5-diaminobenzoic acid, 4-(4′-trifluoromethoxybenzoyloxyl)cyclohexyl 3,5-diaminobenzoate, 4-(4′-trifluoromethylbenzoyloxy)cyclohexyl 3,5-diaminobenzoate, 2,4-diamino-N,N-diallylaniline, 4-aminbenzylamine, 3-aminbenzylamine, 1-(2,4-diaminophenyl)piperazine-4-carboxylic acid, 4-(morpholin-4-yl)benzene-1,3-diamine, 1,3-bis(N-(4-aminophenyl)piperidinyl)propane, a-amino-co-aminophenylalkylene, 4-(2-aminoethyl)aniline, and the compounds of the following formulae (d-2-18) to (d-2-20), etc.

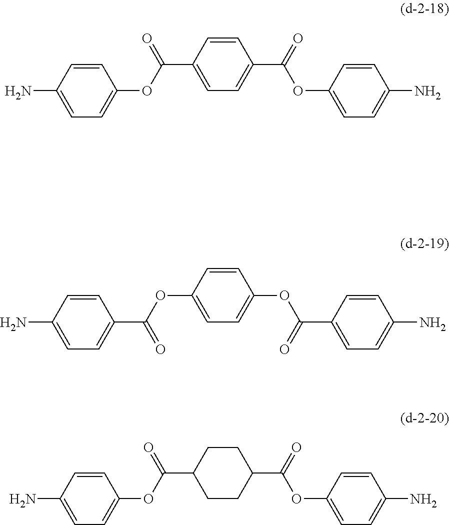 [SMILES: Nc1ccc(OC(=O)c2ccc(C(=O)Oc3ccc(N)cc3)cc2)cc1 ; Nc1ccc(C(=O)Oc2ccc(OC(=O)c3ccc(N)cc3)cc2)cc1 ; Nc1ccc(OC(=O)C2CCC(C(=O)Oc3ccc(N)cc3)CC2)cc1]

In addition, the diamine having no pretilt inducing group as described in JP 2010-97188A may also be used. Such other diamines can be used alone or in combination of two or more.

In the synthesizing the polymer (P), the proportion of the used monomer having the specific moiety is, from the viewpoint of sufficiently obtaining the effects of this invention, preferably 1 to 70 mol %, based on the total amount of the monomers used in the polymerization. If the proportion of the used monomer having the specific moiety is less than 1 mol %, the reliability of the LCD device is difficult to improve. If the proportion exceeds 70 mol %, the strength of the liquid crystal alignment films and the residual-image characteristic of the LCD device tend to be worse. The proportion is more preferably 3 to 60 mol %, still more preferably 5 to 50 mol %, and particularly preferably 10 to 35 mol %. Moreover, from the viewpoint of further improving the effects of this invention, the proportion of the used monomer having the specific moiety is 12.5 to 30 mol %, and preferably 15 to 25 mol %. Moreover, in the case of using method [iii], the proportions of the used specific tetracarboxylic dianhydride and specific diamine are preferably selected such that the total proportion of the used specific tetracarboxylic dianhydride and specific diamine is within the above preferred range.

When the LCD device 10 is a horizontal-alignment LCD device such as a TN type, an STN type, an IPS type or an FFS type, etc., among the used diamines, the proportion of the used diamine with a pretilt-inducing group is preferably not more than a certain value. Specifically, the proportion of the used diamine having a pretilt-inducing group is preferably not more than 20 mol %, more preferably not more than 10 mol %, and still more preferably not more than 5 mol %, based on the amount of the total diamines being used.

On the other hand, in a case of a vertical-alignment LCD device such as a VA-MVA type or a VA-PVA type, among the used diamines, the proportion of the used diamine having a pretilt-inducing group is preferably 1 mol % or more, more preferably 3 to 70 mol % and still more preferably 5 to 60 mol %, based on the amount of the total diamines being used.

In a case that a liquid crystal alignment capability is given to the coating film formed from the above polymer composition with a photo-alignment method, the polyamic acid (P) may be used as a polymer having a photo-alignable structure. Herein, the photo-alignable structure is a concept covering both a photo-alignable group and a decomposable photo-alignment moiety. The photo-alignable structure is a group exhibiting a photo-alignment property based on photo-isomerization, photo-dimerization or photo-decomposition, etc. Specific examples thereof include an azobenzene-containing group that contains azobenzene or its derivative as a basic skeleton, a group having a cinnamic structure that contains cinnamic acid or its derivative as a basic skeleton, a chalcone-containing group that contains chalcone or its derivative as a basic skeleton, a benzophenone-containing group that contains benzophenone or its derivative as a basic skeleton, a coumarin-containing group that contains coumarin or its derivative as a basic skeleton, a polyimide-containing structure that contains polyimide or its derivative as a basic skeleton, a structure having an unsaturated bond that is obtained by introducing a C—C unsaturated bond in a main chain of a polymer, and a structure having an aromatic ring-CO moiety that is obtained by introducing, in a main chain of a polymer, a moiety represented by the following formula (p-1):

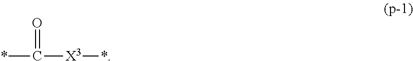

In formula (p-1), X³ is —S—, —O— or —NH—, and the symbols * indicate the respective bonding sites, wherein at least one of the two symbols *-mark bonds is bonded to an aromatic ring.

In the above formula (p-1), the aromatic ring bonded to at least one of X³ and the carbonyl group can be exemplified by a benzene ring, a naphthalene ring, an anthracene ring and so on. From the viewpoint of the liquid crystal alignment effect and transparency, a benzene ring is preferred among the aromatic rings. In the above formula (p-1), the structure at the side of a *-mark bond not bonded to the aromatic ring is not particularly limited, and is exemplified by a hydrocarbon chain, an aliphatic ring, an alicyclic heterocycle, and so on. From the viewpoint of the sensitivity to light, it is preferred that the two *-mark bonds are bonded to aromatic rings, and is more preferred that the two *-mark bonds are bonded to aromatic hydrocarbon rings. From the viewpoint of the sensitivity to light, X³ is preferably —S—. From the viewpoint of availability and a variety of choices of useful monomers, X³ is preferably —O—.

In the polymer composition for forming the liquid crystal alignment films by a photo-alignment method, it is preferred that at least a part of the polymer (P) is a polymer having a photo-alignable structure in its main chain, which is preferably a polymer that has a structure containing polyimide or containing an aromatic ring-CO moiety.

In a case that the polymer (P) has a polyimide-containing structure, the polymer preferably has a bicyclo[2.2.2]octane skeleton, a cyclobutane skeleton or a cyclohexane skeleton. In a case of using the polyamic acid (P), for example, the polymer can be obtained by using, as at least a part of the other tetracarboxylic dianhydride used in the synthesis of the polyamic acid (P), at least one selected from the group consisting of cyclobutanetetracarboxylic dianhydride, cyclohexanetetracarboxylic dianhydride, and bicyclo[2.2.2]octo-7-ene-2,3,5,6-tetracarboxylic dianhydride.

Besides, in a case that the polymer (P) has a structure containing an aromatic ring-CO moiety, the polymer can be obtained by using, as at least a part of the other tetracarboxylic dianhydride used in the synthesis of the polyamic acid (P), a tetracarboxylic dianhydride having a structure containing an aromatic ring-CO moiety, or by using, as at least a part of the other diamine, a diamine having a structure containing an aromatic ring-CO moiety. Specific examples of such monomer include the tetracarboxylic dianhydrides of the above formulae (t-2-10) to (t-2-12) and the diamines of the above formulae (d-2-18) to (d-2-20), etc.

In a case of synthesizing a polymer having a photo-alignable structure in its main chain, from the viewpoint of the photo-reactivity, the proportion of the used monomer having the photo-alignable structure is preferably not less than 20 mol % and more preferably 30 to 80 mol %, based on the total amount of the monomers used in the synthesis of the polymer.

[Synthesis of Polyamic Acid]

The polyamic acid (P) can be obtained by using the above tetracarboxylic dianhydride and diamine, and, if required, a terminal blocking agent. With respect to the proportions of the used tetracarboxylic dianhydride and diamine supplied to the synthesis reaction of the polyamic acid (P), relative to one equivalent of amino group of the diamine, the proportion of the anhydride group of the tetracarboxylic dianhydride is preferably 0.2 to 2 equivalents, and more preferably 0.3 to 1.2 equivalent.

Examples of the terminal blocking agent include: acid monoanhydrides, such as maleic anhydride, phthalic anhydride and itaconic anhydride, etc.; monoamine compounds, such as aniline, cyclohexylamine and n-alkylamine, etc.; and monoisocyanate compounds, such as, phenylisocyanate and naphthylisocyanate, etc.; and so on. Among them, the n-alkylamines having 3 or more carbon atoms is preferred, of which specific examples include n-butylamine, n-hexylamine, n-octylamine, n-laurylamine and n-stearylamine, etc.

The proportion of the terminal blocking agent being used is preferably not more than 20 molar parts, and more preferably not more than 10 molar parts, based on 100 molar parts of the total of the used tetracarboxylic dianhydride and diamine.

The synthesis reaction of the polyamic acid (P) is preferably conducted in an organic solvent. In such cases, the reaction temperature is preferably −20° C. to 150° C. and more preferably 0° C. to 100° C., and the reaction time is preferably 0.1 to 24 hours and more preferably 0.5 to 12 hours.

Examples of the organic solvent used in the reaction include aprotic polar solvents, phenol-type solvents, alcohols, ketones, esters, ethers, halogenated hydrocarbons, and hydrocarbons, etc. Among these organic solvents, at least one selected from the group consisting of aprotic polar solvents and phenol-type solvents (the first group of organic solvents), or a mixture of at least one selected from the first group of organic solvents and at least one selected from the group consisting of alcohols, ketones, esters, ethers, halogenated hydrocarbons, and hydrocarbons (the second group of organic solvents), is preferably used. In the latter case, the proportion of the second group of organic solvents being used is preferably not more than 50 wt %, more preferably not more than 40 wt %, and still more preferably not more than 30 wt %, based on the total amount of the first group and the second group of organic solvents.

Particularly preferably, at least one selected from the group consisting of N-methyl-2-pyrrolidone, N,N-dimethylacetamide, N,N-dimethylformamide, dimethylsulfoxide, γ-butyrolactone, tetramethylurea, hexamethylphosphortriamide, m-cresol, xylenol, and a halogenated phenol is used, or a mixture of at least one of the above solvents and another organic solvent is preferably used in the above range of proportion.

Based on the entire amount of the reaction solution, i.e., the summation (a+b) of the amount (a) of the used organic solvent and the total amount (b) of the used tetracarboxylic dianhydride and diamine and a terminal blocking agent that is optionally used if required, the amount (a) of the used organic solvent is preferably 0.1 to 50 wt %.

As mentioned above, a reaction solution is obtained by dissolving a polyamic acid. It is possible to supply the reaction solution directly to prepare a polymer composition, to separate the polyamic acid contained in the reaction solution and supply the same to prepare a polymer composition, or to purify the separated polyamic acid and supply the resultant to prepare a polymer composition. Separation and purification of the polyamic acid can be carried out using well-known methods.

[Polyamic Ester]

The polyamic ester as the above polymer (P) may be obtained using the methods [1] to [3], etc. Method [1] is reacting the polyamic acid (P) synthesized as above with an esterification agent. Method [2] is reacting a tetracarboxylic diester with a diamine. Method [3] is reacting a tetracarboxylic diester dihalide with a diamine.

Examples of the esterification agent used in method [1] include: compounds containing a hydroxyl group, such as alcohols (such as methanol, ethanol and propanol, etc.) and phenols (such as phenol and cresol, etc.), etc.; acetal-type compounds, such as N,N-dimethylformamidediethylacetal and N,N-diethylformamidediethylacetal, etc.; halogenated compounds, such as methyl bromide, ethyl bromide, stearyl bromide, methyl chloride, stearyl chloride, and 1,1,1-trifluoro-2-iodoethane, etc.; and compounds containing an epoxy group, such as propylene oxide, etc.; and so on.

The tetracarboxylic diester used in method [2] can be obtained by using the above alcohol to open the rings of a tetracarboxylic dianhydride. Moreover, the tetracarboxylic diester dihalide used in method [3] can be obtained by reacting the tetracarboxylic diester obtained as above with a suitable chlorination agent such as thionyl chloride. The diamine used in methods [2] and [3] preferably contains the above specific diamine, and, if required, may also contain the above other diamine. Moreover, the polyamic ester may have amic ester structures only, or may be a partially esterified compound including both amic acid structures and amic ester structures.

[Polyimide]

The polyimide contained in the polymer composition of this invention may be obtained by, e.g., performing dehydration cyclization to the polyamic acid synthesized as above to imidize it.

The above polyimide may be a fully imidized compound obtained by dehydration-cyclizing all the amic acid structures of the polyamic acid as its precursor, or a partially imidized compound including both amic acid structures and imide ring structures that is obtained by dehydration-cyclizing only a part of the amic acid structures. From the viewpoint of the electrical properties, the imidization ratio of the polyimide used in this invention is preferably not less than 30%, more preferably not less than 50%, and still more preferably not less than 65%. On the other hand, from the viewpoint of ensuring the solubility of the polymer and improving the coating property, the imidization ratio is preferably not more than 65%, and more preferably not more than 30%. The imidization ratio is defined as the percentage of the number of the imide ring structures based on the total number of the auric acid structures and the imide ring structures in the polyimide. Herein, a part of the imide rings may be isoimide rings.

Dehydration cyclization of the polyamic acid is preferably carried out by i) heating the polyamic acid, or ii) dissolving the polyamic acid in an organic solvent and adding a dehydrating agent and a dehydration-cyclization catalyst in the resulting solution, and, if required, heating.

In the above method i), the reaction temperature is preferably 50° C. to 200° C., and more preferably 60° C. to 170° C. If the reaction temperature is lower than 50° C., the dehydration cyclization reaction is difficult to proceed. If the reaction temperature exceeds 200° C., the molecular weight of the polymer becomes lower. The reaction time is preferably 1.0 to 24 hours, and more preferably 1.0 to 12 hours.

In the above method ii), as the dehydrating agent, for example, acetic anhydride, propionic anhydride, or trifluoroacetic anhydride, etc. can be used. The amount of the dehydrating agent being used depends on the desired imidization ratio, and is preferably 0.01 to 20 moles based on 1 mole of the auric acid structures of the polyamic acid. Meanwhile, as the dehydration-cyclization catalyst, for example, pyridine, collidine, lutidine, or a tertiary amine such as trimethylamine can be used. The amount of the dehydration-cyclization catalyst being used is preferably 0.01 to 10 moles based on 1 mole of the used dehydrating agent.

Examples of the organic solvent used for the dehydration cyclization reaction can be the same as the aforementioned examples of the organic solvent used in synthesizing the polyamic acid. The reaction temperature of the dehydration cyclization reaction is preferably 0° C. to 180° C., and more preferably 10° C. to 150° C. The reaction time is preferably 1.0 to 120 hours, and more preferably 2.0 to 30 hours.

In this way, a reaction solution containing polyimide is obtained. It is possible to directly supply the reaction solution to prepare a polymer composition, to remove the dehydrating agent and the dehydration-cyclization catalyst from the reaction solution and then supply the resultant to prepare a polymer composition, to separate the polyimide and supply the same to prepare a polymer composition, or to purify the separated polyamide and supply the resultant to prepare a polymer composition. Such purification operation can be carried out using a well-known method.

As contained in a solution in a concentration of 10 wt %, the polyamic acid, polyamic ester or polyimide obtained as above preferably has a solution viscosity of 10 to 800 mPa·s, more preferably 15 to 500 mPa·s. The solution viscosity (mPa·s) of the above polymer is measured using an E-type rotary viscometer at 25° C. after a good solvent of the polymer, such as γ-butyrolactone or N-methyl-2-pyrollidone, etc., is used to prepare a polymer solution having a concentration of 10 wt %.

As measured by gel permeation chromatography (GPC), the polystyrene equivalent weight average molecular weight of the polyamic acid, polyamic ester or polyimide contained in the polymer composition is preferably 1,000 to 500,000, and more preferably 2,000 to 300,000.

[Other Components]

The above polymer composition may also contain other components, if needed. Examples thereof include a polymer other than the above polymer (P), a compound having at least one epoxy group in the molecule (called “epoxy compound” hereinafter), and a functional silane compound, etc.

[Other Polymer]

The above other polymer may be used for improving, for example, the solution property (coating property) and the electrical property of the polymer composition. Such other polymer does not contain the above specific moiety in its main chain, and the main skeleton thereof is not particularly limited. Specific examples of the main skeleton thereof include a polyamic acid, a polyimide, a polyamic ester, a polyorganosiloxane, a polyester, a polyamide, a cellulose derivative, a polyacetal, a polystyrene derivative, a poly(styrene-phenylmaleimide) derivative, and a poly(meth)acrylate, etc. Among them, it is preferred to use at least one polymer selected from the group consisting of a polyamic acid, a polyamic ester, a polyimide and a polyorganosiloxane. Moreover, such other polymer may be synthesized using a well-known method, or may be a commercially available product.

The proportion of such other polymer being used is preferably not more than 50 weight parts and more preferably not more than 30 weight parts, based on 100 weight parts of the polymer (P).

[Epoxy Compound]

The above epoxy compound can be used to improve, for example, the adhesion with the substrate surface and the electrical properties of the liquid crystal alignment films. Preferred specific examples of the epoxy compound include: ethylene glycol diglycidyl ether, polyethyleneglycol diglycidyl ether, propylene glycol diglycidyl ether, tripropyleneglycol diglycidyl ether, polypropyleneglycol diglycidyl ether, neopentyl glycol diglycidyl ether, 1,6-hexanediol diglycidyl ether, glycerin diglycidyl ether, trimethylolpropane triglycidyl ether, 2,2-dibromoneopentyl glycol diglycidyl ether, N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane, N,N-diglycidyl-benzylamine, N,N-diglycidyl-aminomethylcyclohexane, and N,N-diglycidyl-cyclohexylamine, etc.

In a case that the above epoxy compound is mixed in the polymer composition, the mixing proportion thereof is preferably not more than 40 weight parts, and more preferably 0.1 to 30 weight parts, based on 100 weight parts of the polymer (P).

[Functional Silane Compound]

The above functional silane compound can be used to improve, for example, the printability of the polymer composition. Examples of the functional silane compound include: 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-triethoxysilylpropyltriethylenetriamine, 10-trimethoxysilyl-1,4,7-triazadecane, 9-trimethoxysilyl-3,6-diazanonyl acetate, ethyl 9-trimethoxysilyl-3,6-diazanonoate, N-benzyl-3-aminopropyltrimethoxysilane, N-phenyl-3-aminopropyltrimethoxysilane, glycidoxymethyltrimethoxysilane, 2-glycidoxyethyltrimethoxysane, and 3-glycidoxypropyltrimethoxysilane, etc.

In a case that the above functional silane compound is mixed in the polymer composition, the mixing proportion thereof is preferably not more than 2 weight parts, and more preferably 0.02 to 0.2 weight part, based on 100 weight parts of the polymer (P).

In addition to the aforementioned, the examples of the other components also include a compound having at least one oxetanyl group in the molecule, a bismaleimide compound, an antioxidant, and a photo-sensitizer, etc. The amount of such other component being mixed can be suitably adjusted within the range not reducing the effects of this invention.

[Solvent]

The above polymer composition is preferably prepared as a liquid composition by dissolving or dispersing, in an organic solvent, the above polymer (P), and other components that are mixed as needed.

Examples of the useful solvents include N-methyl-2-pyrrolidone, γ-butyrolactone, γ-butyrolactam, N,N-dimethylformamide, N,N-dimethylacetamide, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol i-propyl ether, ethylene glycol n-butyl ether (butyl cellosolve), ethylene glycol dimethyl ether, ethylene glycol ethyl ether acetate, diethyleneglycol dimethyl ether, diethyleneglycol diethyl ether, diethyleneglycol monomethyl ether, diethyleneglycol monoethyl ether, diethyleneglycol monomethyl ether acetate, diethyleneglycol monoethyl ether acetate, dipropyleneglycol monomethyl ether (DPM), diisobutyl ketone, isoamyl propionate, isoamyl isobutyrate, diisopentyl ether, ethylene carbonate, and propylene carbonate, etc. These solvents can be used alone, or in combination of two or more.

The solid content of the polymer composition, which is the proportion of the total weight of the components other than the solvent of the polymer composition in the entire weight of the polymer composition, can be suitably selected in consideration of viscosity, volatility and so on, but is preferably in the range of 1 to 10 wt %. Specifically, the polymer composition is coated on the substrate surfaces and preferably heated to form coating films that are the liquid crystal alignment films or will become the liquid crystal alignment films, as described later. In the stage, if the solid content is less than 1 wt %, the thickness of the coating films is overly small so that good liquid crystal alignment films are difficult to obtain; if the solid content is more than 10 wt %, the thickness of the coating films is overly large so that good liquid crystal alignment films are difficult to obtain and the viscosity of the polymer composition is increased degrading the coating properties.

The particularly preferred range of the solid content varies with the method for coating the polymer composition on the substrate. For example, in a case using a spinner method, the solid content is particularly preferably in the range of 1.5 to 4.5 wt %. In a case using a printing method, the solid content is particularly preferably in the range of 3 to 9 wt % so that the solution viscosity is in the range of 12 to 50 mPa·s. In a case using an ink jet method, the solid content is particularly preferably in the range of 1 to 5 wt % so that the solution viscosity is in the range of 3 to 15 mPa·s. The temperature at which the polymer composition is prepared is preferably 10 to 45° C., and more preferably 20 to 30° C.

<Method for Fabricating LCD Device>

Next, the method for fabricating the LCD device 10 is described. The LCD device 10 can be fabricated with a method including step (1) of coating the above polymer composition on the respective surfaces of the pair of substrates (array substrate 11 and opposite substrate 14) to form coating films, step (2) of coating the sealing material on the surface of the coating film on at least one of the pair of substrates 11 and 14, and step (3) of arranging the pair of substrates 11 and 14 such that the coating films face each other as being separated by the sealing material on the surfaces of the coating films to construct a liquid crystal cell. Moreover, the used substrate varies with the desired driving mode in step (1), and steps (2) and (3) do not vary with the same.

[Step (1): Formation of Coating Films]

In a case of fabricating an LCD device 10 of TN, STN, VA or MVA type, on the surfaces of the respective substrates where the transparent conductive films are formed, the above polymer composition is coated respectively, preferably using an offset printing method, a spin-coating method, a roll coating method, or an ink-jet printing method. While the polymer composition is coated, in order to further improve the adhesion between the coating films and the substrate surfaces or the transparent conductive films, the surfaces to be formed with the coating films among the substrate surfaces may be previously subjected to a pre-treatment of coating a functional silane compound or a functional titanium compound, etc.

Moreover, a patterned transparent conductive film can be obtained by, for example, forming an unpatterned transparent conductive film and then forming patterns with lithography and etching, or using a mask having desired patterns in forming the transparent conductive film.

After the polymer composition is coated, for purposes such as preventing drip of the coated composition, pre-heating is preferably performed. The temperature of the pre-heating is preferably 30 to 200° C., more preferably 40 to 150° C., and particularly preferably 40 to 100° C. The pre-heating time is preferably 0.25 to 10 min and more preferably 0.5 to 5 min. Thereafter, in order to completely remove the solvent and, if required, to thermally imidize the amic acid structures remaining in the polymer, a post-baking step is performed. The post-baking temperature is preferably 80 to 300° C., and more preferably 120 to 250° C. The post-baking time is preferably 5 to 200 min, and more preferably 10 to 100 min.

After the polymer composition is coated on the substrates, the organic solvent is removed to form the liquid crystal alignment films or the coating films for forming the liquid crystal alignment films. In a case that the polymer contained in the polymer composition is a polyamic acid, a polyamic ester, or an imidized polymer having imide ring structures and amic acid structures, after the coating films are formed, further heating may be carried out to perform a dehydration cyclization reaction and obtain further imidized coating films.

[Step (1-1): Treatment for Giving Alignment Capability]

In a case of fabricating an LCD device of TN or STN type, a treatment for giving a liquid crystal alignment capability is performed on the coating films formed in the above step (1). Thereby, a capability of aligning liquid crystal molecules is given to the coating films to form the liquid crystal alignment films 17 and 18. Examples of the treatment for giving alignment capability include a rubbing treatment of rubbing the coating film in a certain direction using, for example, a roll of a wound cloth made from fibers of nylon, rayon or cotton, etc., and a photo-alignment treatment of irradiating the coating film with a polarized or non-polarized radiation. On the other hand, in a case of fabricating a vertical-alignment LCD device, the coating films formed in the above step (1) can be directly used as liquid crystal alignment films. However, a treatment for giving an alignment capability may still be applied to the coating films.

In the photo-alignment treatment, as the radiation for irradiating the coating films, UV light and visible light of which the wavelength ranges from 150 to 800 nm can be used. In a case where the radiation is polarized, the radiation may be linearly polarized or partially polarized. Moreover, in a case where the radiation is linearly polarized or partially polarized, the irradiation may be performed in a direction perpendicular to the substrate surface, in an inclined direction, or in a combination of both. In a case where non-polarized radiation is used, the irradiation is performed in an inclined direction.

The light source being used may be a low-pressure mercury lamp, a high-pressure mercury lamp, a deuterium lamp, a metal halide lamp, an argon resonance lamp, a xenon lamp, or an excimer laser, etc. UV light in a preferred wavelength range may be obtained by, e.g., a means in which a light source is used in combination with, e.g., a filter or a diffraction grating, etc. The irradiation dose of the radiation is preferably 100 to 50,000 J/m², and more preferably 300 to 20,000 J/m². Moreover, the light irradiation to the coating film may be performed while the coating film is heated to raise the reactivity. The temperature in the heating step is usually 30 to 250° C., preferably 40 to 200° C., and more preferably 50 to 150° C.

Moreover, the liquid crystal alignment film after the rubbing treatment may be subjected to a treatment in which the liquid crystal alignment film is partially irradiated with UV light to change the pretilt angle of a part of the regions thereof, or to a treatment in which a resist film is formed on parts of the surface of the liquid crystal alignment film, another rubbing treatment is performed in a direction different form that of the precedent rubbing treatment and then the resist film is removed, so as to make the liquid crystal alignment film have different liquid crystal alignment capabilities in different regions. In such case, it is possible to improve the vision field characteristic of the obtained LCD device.

A liquid crystal alignment film suitable for a vertical alignment LCD device can also be suitably used in a PSA (polymer sustained alignment) LCD device. In a case of fabricating a PSA LCD device, the coating films formed in the above step (1) may be directly used to perform the next step, or may be subjected to a weak rubbing treatment for the purpose of controlling flip-flopping of the liquid crystal molecules and performing alignment partition in a simple way.

[Step (2): Coating of Sealing Material]

The two substrates 11 and 14 formed with the liquid crystal alignment films 17 and 18 are prepared as above, and a sealing material is coated on the surface of the liquid crystal alignment film 17 or 18 on at least one of the substrate 11 and 14 along a peripheral portion of the at least one substrate. The sealing material can be coated with, e.g., a screen printing method.

[Step (3): Construction of Liquid Crystal Cell]

Next, a liquid crystal is disposed between the two substrates disposed opposite to each other to fabricate a liquid crystal cell. The fabrication can be done with, e.g., the two methods below.

The first method has been known in the prior art. First, the pair of substrates 11 and 14 is arranged opposite to each other with their liquid crystal alignment films 17 and 18 facing each other and with a cell gap between them, and the two substrates are bonded together via the sealing material. Thereafter, a liquid crystal is injected and filled in the cell gap defined by the substrate surfaces and the sealing material, and then the injection hole is sealed to finish fabricating the liquid crystal cell.

The second method is the so-called ODF (one drop fill) method, in which a liquid crystal is dripped on the surface of the liquid crystal alignment film of the substrate having been coated with the sealing material, the other substrate is bonded thereto with the liquid crystal alignment films facing each other, the liquid crystal is pressed to spread on entire surfaces of the substrates, and then the entire surfaces of the substrates are irradiated with UV light to cure the sealing material and finish fabricating the liquid crystal cell. In the case of using either method, for the liquid crystal cell fabricated as above, it is desired to heat the used liquid crystal to a temperature of the isotropic phase and slowly cool the same to room temperature so as to remove the flowing alignment generated in the filling of the liquid crystal.

Further, in a case of fabricating a PSA LCD device, a liquid crystal cell is constructed as above except that the liquid crystal is injected or dripped together with a photo-polymerizable compound. Thereafter, the liquid crystal cell is irradiated with light while a voltage is applied between the conductive films of the pair of substrates.

The voltage applied herein can be, e.g., a DC or AC voltage of 5 to 50V. Moreover, the light that can be used for irradiation include, e.g., UV light and visible light having wavelengths of 150 to 800 nm, but the light is preferably UV light having a wavelength of 300 to 400 nm. The source of irradiation light being used may be a low-pressure mercury lamp, a high-pressure mercury lamp, a deuterium lamp, a metal halide lamp, an argon resonance lamp, a xenon lamp, or an excimer laser, etc. UV light in the above preferred wavelength range may be obtained by, e.g., a means in which a light source is used in combination with, e.g., a filter or a diffraction grating, etc. The irradiation dose of the light is preferably greater than or equal to 1,000 J/m² and less than 200,000 J/m², and more preferably 1,000 to 100,000 J/m².

Then, by bonding polarizing plates to the outer surfaces of the liquid crystal cell, the LCD device 10 can be obtained. Moreover, in a case that a rubbing treatment is performed on the coating films, the two substrates are arranged opposite to each other in a manner such that the respective rubbing directions of the respective coating films form a predetermined angle, such as an orthogonal angle or an antiparallel angle.

### Second Embodiment

Next, the LCD device of the second embodiment is described centered on the difference from the first embodiment. The LCD device 10 of this embodiment is different that of the first embodiment in that the sealing part 19 is disposed on the surfaces of the liquid crystal alignment films 17 and 18 and the opposite surfaces of the array substrate 11 and the opposite substrate 14.

FIG. 2 schematically illustrates an LCD device 10 of this embodiment. As shown in FIG. 2, the LCD device 10 includes a pair of substrates including an array substrate 11 and an opposite substrate 14, liquid crystal alignment films 17 and 18, a sealing part 19, and a liquid crystal layer 22. The liquid crystal alignment films 17 and 18 are formed on the opposite surfaces of the substrates 11 and 14 at the inner side of the peripheral portions of the substrates, and the sealing part 19 is disposed on the regions of the opposite surfaces not formed with the crystal alignment films 17 and 18 and on the surfaces of the liquid crystal alignment films 17 and 18. Moreover, the liquid crystal alignment films 17 and 18 are formed using the polymer composition of the above first embodiment, and a description of this is omitted hereinafter.

### Other Embodiments

The operation mode of the LCD device of this invention is not limited to the above mentioned, and may alternatively be a transverse electric field mode of the IPS or FFS type. Herein, an LCD device of transverse electric field mode includes a pair of substrates that include a substrate on which electrodes including a transparent conductive film or a metal film patterned into a comb shape are disposed, and an opposite substrate on which no electrode is formed. The materials of the used substrate and transparent conductive film and the methods for patterning the transparent conductive film or the metal film are the same as those mentioned for the first embodiment. As the metal film, for example, a film including a metal such as chromium can be used.

Moreover, the driving method of the LCD device of this invention is not limited to an active matrix method using TFTs, and may alternatively be a simple matrix method.

The LCD device of this invention can be effectively applied to various apparatuses, such as the display apparatuses of watch, portable game machine, word processor, notebook personal computer, car navigation system, camcorder, PDA, digital camera, portable phone, smart phone, various monitors, and liquid crystal television, etc.

### Examples

This invention will be described more specifically with examples, but is not limited by these examples.

In the Synthesis Examples below, the imidization ratio of the polyimide in the polymer solution and the viscosity of the polymer solution were measured with the following methods.

### [Imidization Ratio of Polyimide]

A polyimide solution was poured in pure water, the obtained precipitates were sufficiently dried under a reduced pressure at room temperature, dissolved in deuterated dimethylsulfoxide, and then measured for the ¹H-NMR spectrum at room temperature using tetramethylsilane as a standard material. Based on the obtained ¹H-NMR spectrum, the imidization ratio (%) could be derived with the following Equation (1).

Imidization ratio (%)=(1−A¹/A²×α)×100 (1)

In Equation (1), A¹ is the area of the peak of the proton of the NH group near the chemical shift of 10 ppm, A² is the area of the peaks of the other protons, and a is the number of the other protons per proton of the NH group in the precursor (polyamic acid) of the polymer.

### [Solution Viscosity of Polymer Solution]

A polymer solution, which was prepared using a predetermined solvent to have a polymer concentration of 10 wt %, was measured for the solution viscosity (mPa·s) at 25° C. using an E-type rotary viscometer.

[Synthesis of Polymer]

In the Synthesis Examples described later, the monomers below were used for syntheses.

### [Tetracarboxylic Dianhydride]

Carboxylic Dianhydrides Containing a Long Alkylene Chain:

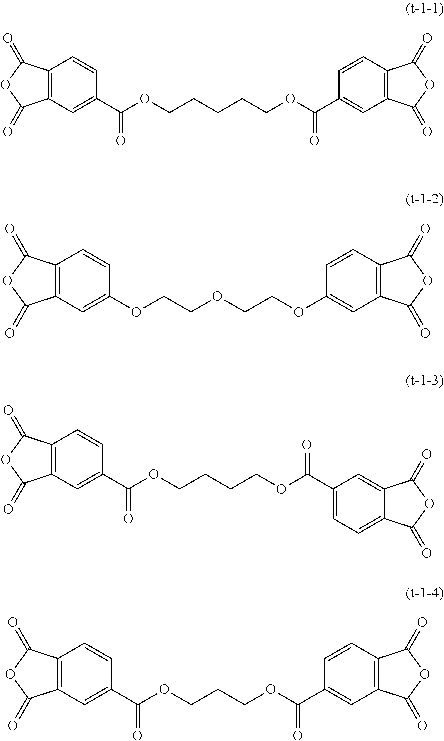 [SMILES: O=C(OCCCCCOC(=O)c1ccc2c(c1)C(=O)OC2=O)c1ccc2c(c1)C(=O)OC2=O ; O=C1OC(=O)c2cc(OCCOCCOc3ccc4c(c3)C(=O)OC4=O)ccc21 ; O=C(OCCCCOC(=O)c1ccc2c(c1)C(=O)OC2=O)c1ccc2c(c1)C(=O)OC2=O ; O=C(OCCCOC(=O)c1ccc2c(c1)C(=O)OC2=O)c1ccc2c(c1)C(=O)OC2=O]

Other Tetracarboxylic Dianhydrides:

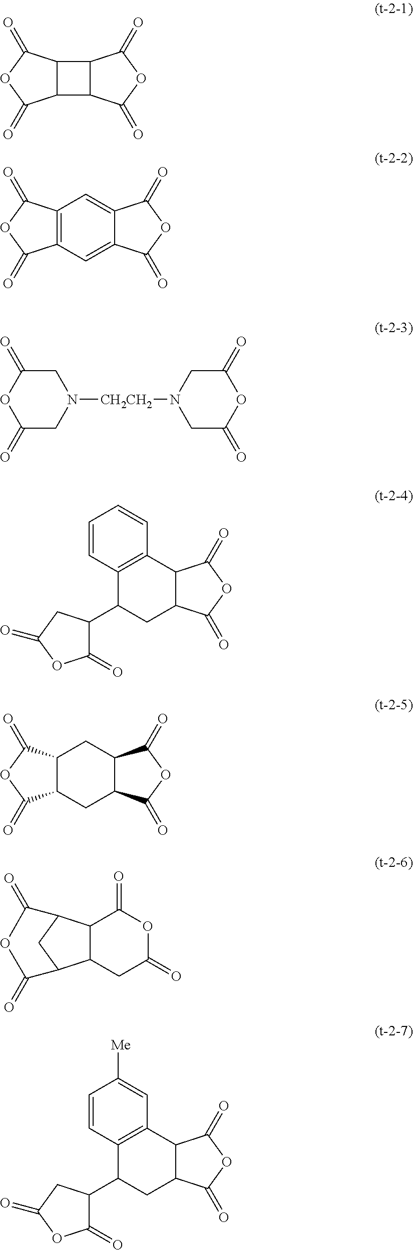

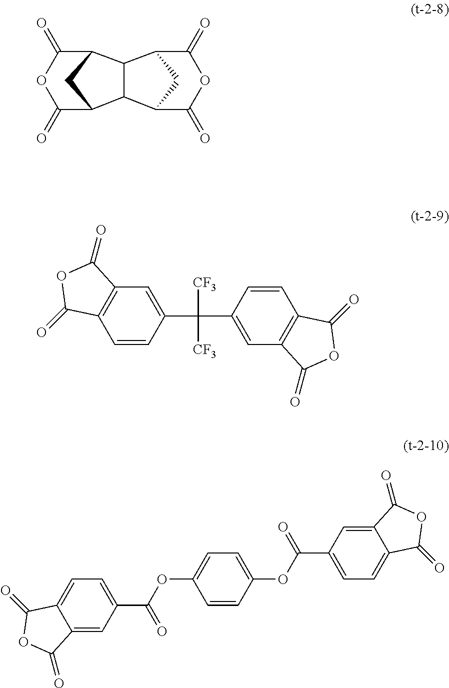 [SMILES: O=C1OC(=O)[C@@H]2C[C@H]1C1C2[C@H]2C[C@@H]1C(=O)OC2=O ; O=C1OC(=O)c2cc(C(c3ccc4c(c3)C(=O)OC4=O)(C(F)(F)F)C(F)(F)F)ccc21 ; O=C(Oc1ccc(OC(=O)c2ccc3c(c2)C(=O)OC3=O)cc1)c1ccc2c(c1)C(=O)OC2=O]

[Diamine]

Diamines Containing a Long Alkylene Chain:

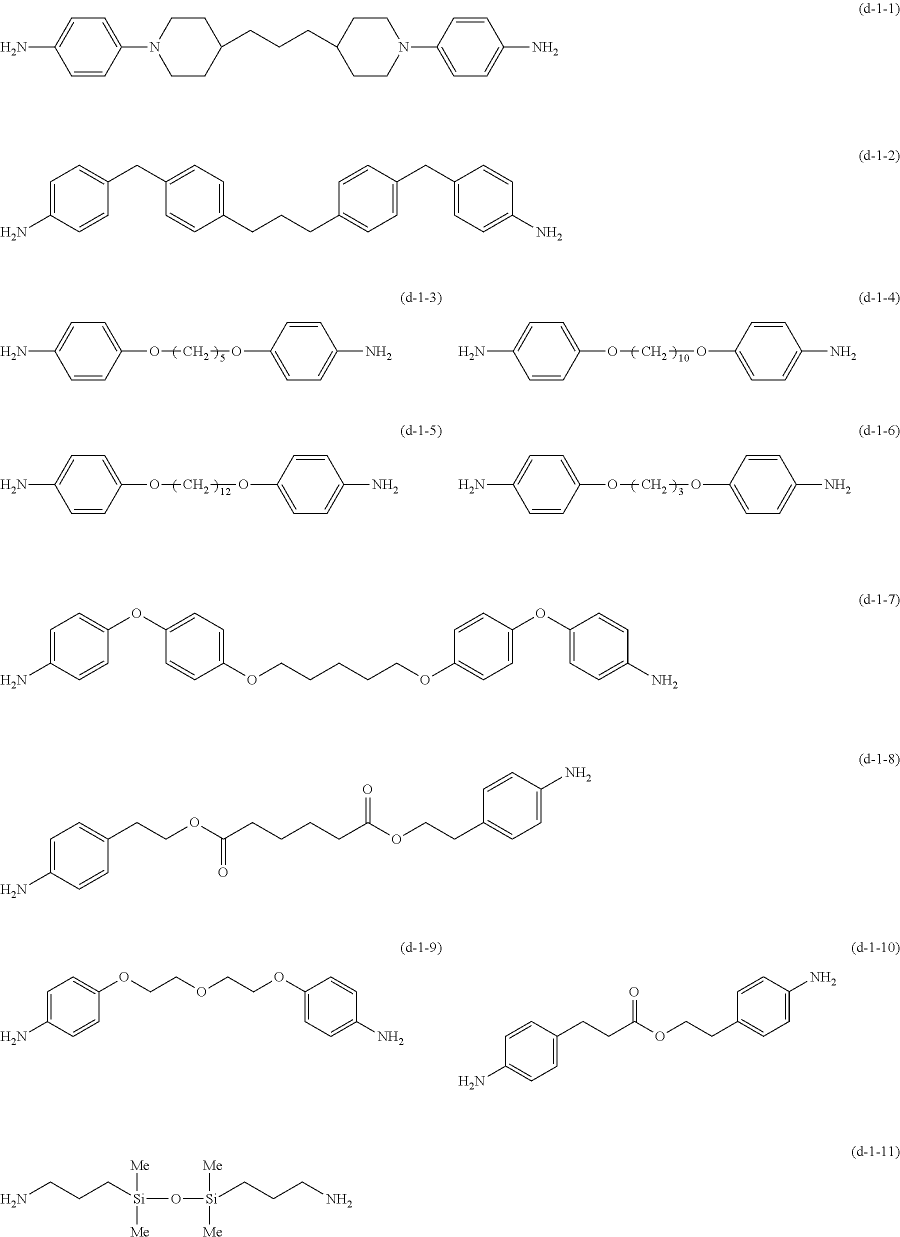

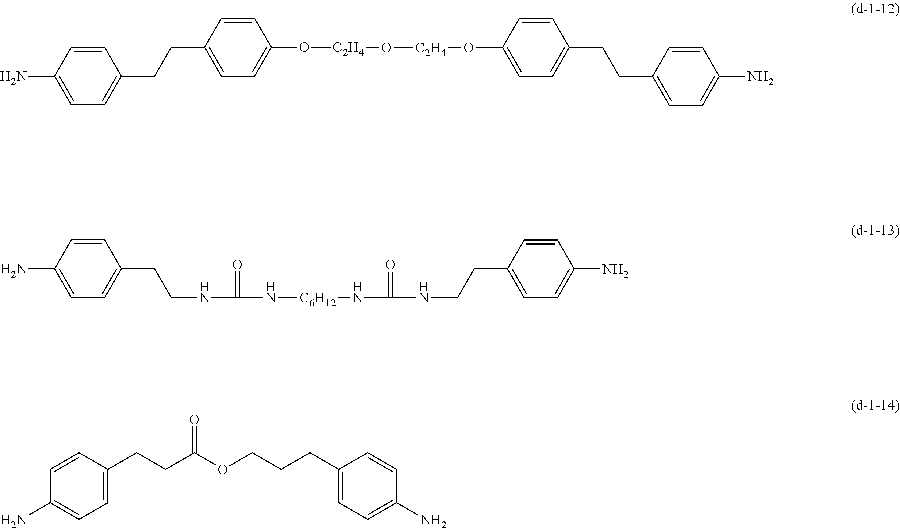

Other Diamines

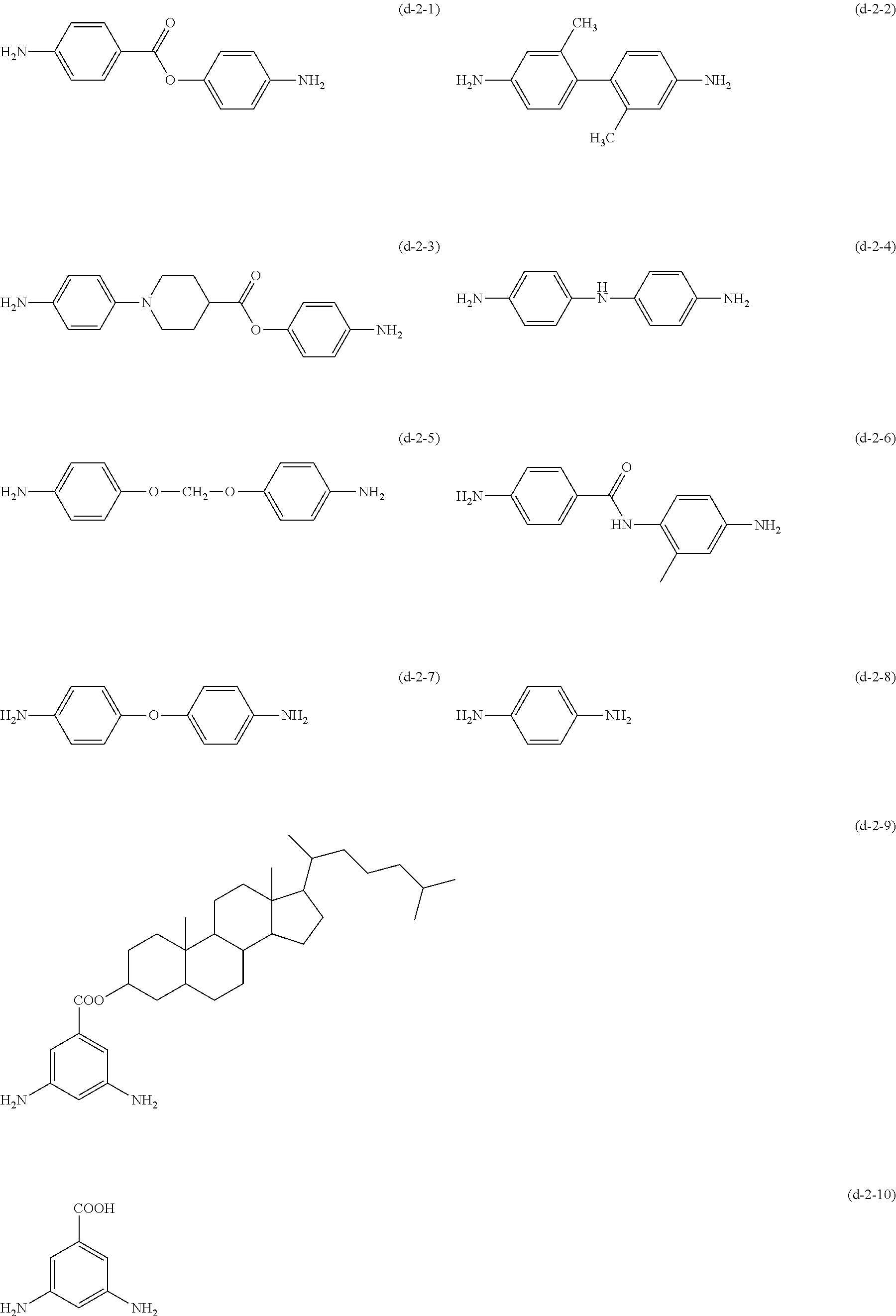

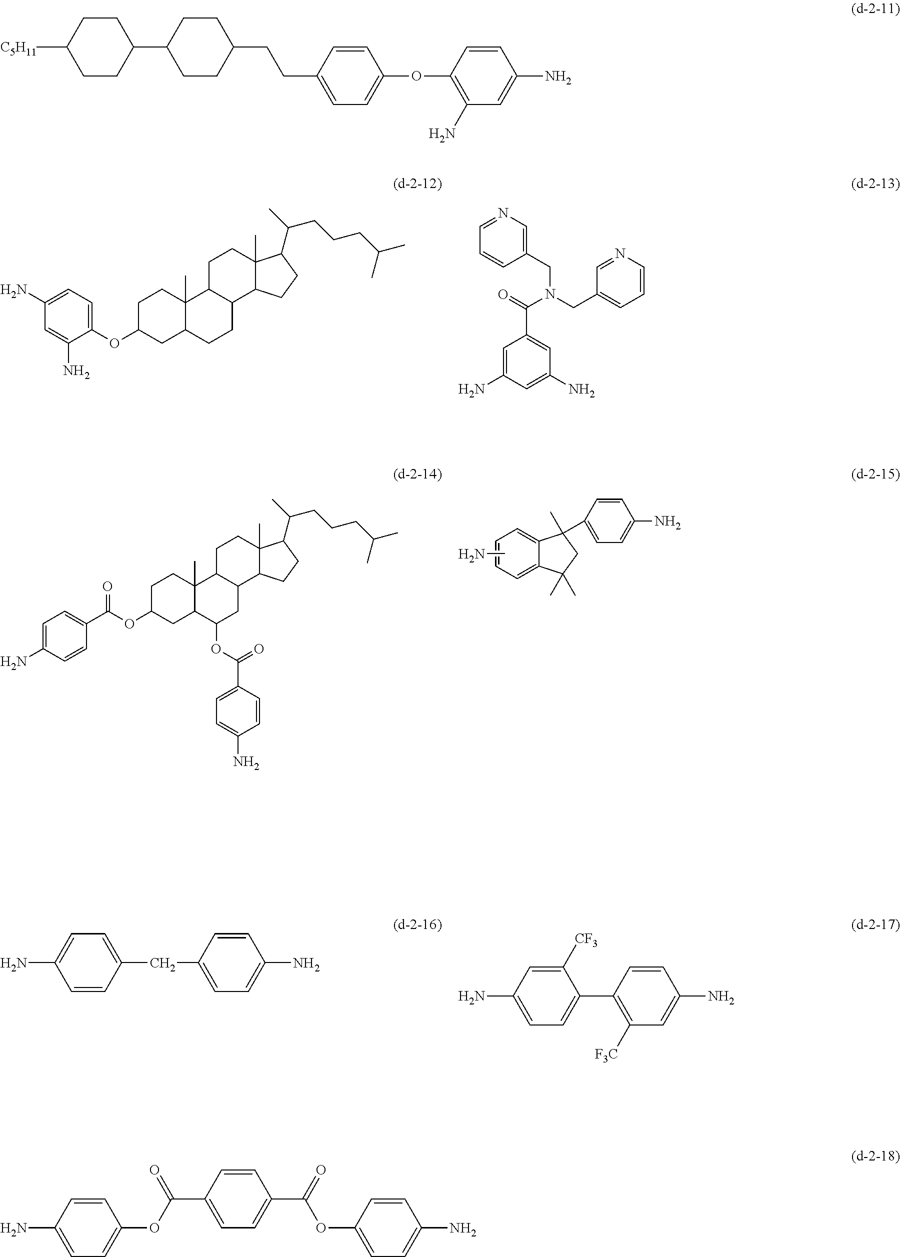

In the following descriptions, a compound represented by formula X is sometimes referred to as “compound X”.

### Synthesis of Polyamic Acid

### Synthesis Example 1

### Synthesis of Polymer (PAA-1)

95 molar parts of cyclobutanetetracarboxylic dianhydride and 5 molar parts of pyromellitic dianhydride as the tetracarboxylic dianhydride, and 10 molar parts of compound (d-1-1), 60 molar parts of 4-aminophenyl 4′-aminobenzoate and 30 molar parts of compound (d-2-2) as the diamine were dissolved in a mixed solvent of N-methyl-2-pyrrolidone (NMP) and γ-butyrolactone (γBL) [NMP:γBL=10:90 (weight ratio)] and reacted at 40° C. for 3 hours to obtain a solution containing 10 wt % of a polyamic acid [polymer (PAA-1)]. A small fraction of the obtained solution was taken out and measured to have a solution viscosity of 100 mPa·s.

### Synthesis Example 2 to 16

### Synthesis of Polymers (PAA-2) to (PAA-16)

Except that the species and the amounts of the tetracarboxylic dianhydride and the diamine were changed as in Table 1 below, the same operation as described in Synthesis Example 1 was performed to prepare polymer solutions containing polymers (PAA-2) to (PAA-16), respectively.

TABLE 1

| | | Monomer (mixing proportion/molar part) | | | | | | |
|---|---|---|---|---|---|---|---|---|
| Polyamic | Name of | Carboxylic dianhydride | | | | Diamine | | |
| acid | polymer | Long alkylene chain | Others | | | Long alkylene chain | Others | |
| Synthesis | PAA-1 | — | t-2-1 | t-2-2 | — | d-1-1 (10) | d-2-1 | d-2-2 |
| Example 1 | | | (95) | (5) | | | (60) | (30) |
| Synthesis | PAA-2 | — | t-2-1 | t-2-2 | — | d-1-1 (30) | d-2-1 | — |
| Example 2 | | | (95) | (5) | | | (70) | |
| Synthesis | PAA-3 | — | t-2-1 | t-2-2 | t-2-3 | d-1-1 (50) | d-2-1 | d-2-3 |
| Example 3 | | | (65) | (5) | (30) | | (40) | (10) |
| Synthesis | PAA-4 | — | t-2-1 | t-2-2 | t-2-3 | d-1-1 (70) | d-2-1 | — |
| Example 4 | | | (65) | (5) | (30) | | (30) | |
| Synthesis | PAA-5 | — | t-2-1 | t-2-2 | — | — | d-2-1 | d-2-4 |
| Example 5 | | | (95) | (5) | | | (70) | (30) |
| Synthesis | PAA-6 | — | t-2-1 | — | t-2-4 | — | d-2-2 | d-2-5 |
| Example 6 | | | (50) | | (50) | | (60) | (40) |
| Synthesis | PAA-7 | — | t-2-1 | — | t-2-5 | d-1-2 (40) | d-2-2 | — |
| Example 7 | | | (50) | | (50) | | (60) | |
| Synthesis | PAA-8 | — | t-2-1 | — | t-2-4 | d-1-3 (40) | d-2-2 | — |
| Example 8 | | | (50) | | (50) | | (60) | |
| Synthesis | PAA-9 | — | t-2-1 | — | t-2-4 | d-1-4 (40) | d-2-2 | — |
| Example 9 | | | (50) | | (50) | | (60) | |
| Synthesis | PAA-10 | — | t-2-1 | — | t-2-4 | d-1-5 (40) | — | d-2-6 |
| Example 10 | | | (50) | | (50) | | | (60) |
| Synthesis | PAA-11 | — | t-2-1 | — | — | — | d-2-2 | — |
| Example 11 | | | (100) | | | | (100) | |
| Synthesis | PAA-12 | t-1-1 (15) | t-2-1 | t-2-2 | — | — | d-2-7 | d-2-8 |
| Example 12 | | | (10) | (75) | | | (80) | (20) |
| Synthesis | PAA-13 | t-1-2 (50) | t-2-1 | t-2-2 | — | — | d-2-7 | d-2-8 |
| Example 13 | | | (10) | (40) | | | (80) | (20) |
| Synthesis | PAA-14 | — | t-2-1 | t-2-2 | — | — | d-2-7 | d-2-8 |
| Example 14 | | | (10) | (90) | | | (80) | (20) |
| Synthesis | PAA-15 | t-1-4 (100) | — | — | — | — | d-2-18 | — |
| Example 15 | | | | | | | (100) | |
| Synthesis | PAA-16 | — | t-2-5 | — | — | — | d-2-18 | — |
| Example 16 | | | (100) | | | | (100) | |

The numerical values in Table 1 are mixing proportions (molar part) of the respective compounds relative to 100 molar parts of the total amount of the tetracarboxylic dianhydride used in the synthesis of the polymer. The symbol “-” in Table 1 means that a raw material of the corresponding column was not used, and the same rule is applied to Tables 2 and 3 below.

### Synthesis of Polyimide

### Synthesis Example 17

### Synthesis of Polymer (PI-1)

100 molar parts of 2,3,5-tricarboxycyclopentylacetic dianhydride as the tetracarboxylic dianhydride, and 25 molar parts of compound (d-1-6), 55 molar parts of p-phenylenediamine and 20 molar parts of cholestanyl 3,5-diaminobenzoate as the diamine were dissolved in NMP and reacted at 60° C. for 6 hours to obtain a solution containing 20 wt % of polyamic acid. A small fraction of the obtained polyamic acid solution was taken out and diluted by NMP into a solution having a polyamic acid concentration of 10 wt %, and the solution viscosity of the resulting solution was measured to be 90 mPa·s.

Next, NMP was further added to the obtained polyamic acid solution to obtain a solution having a polyamic acid concentration of 7 wt %, pyridine and acetic anhydride each in a molar number 1.0 time the molar number of the total amount of the used tetracarboxylic dianhydride were added, and a dehydration cyclization reaction was performed at 110° C. for 4 hours. After the dehydration cyclization reaction, the solvent in the system was substituted by new NMP to obtain a solution containing 26 wt % of polyimide (PI-1) having an imidization ratio of about 60%. A small fraction of the obtained polyamic acid solution was taken out and diluted by NMP into a solution having a polyamic acid concentration of 10 wt %, and the solution viscosity of the resulting solution was measured to be 80 mPa·s.

### Synthesis Examples 18 to 34

### Syntheses of Polymers (PI-2) to (PI-18)

Except that the species and amounts of the tetracarboxylic dianhydride and the diamine were changed as in Table 2 below, the same operation as described in Synthesis Example 17 was performed to prepare polymer solutions containing polymers (PI-2) to (PI-18), respectively. Moreover, in Synthesis Examples 24 to 29, n-stearylamine was mixed with the tetracarboxylic dianhydride and the diamine in an amount described in Table 2.

TABLE 2

| | | Monomer (mixing proportion/molar part) | | | | | |
|---|---|---|---|---|---|---|---|
| | Name of | Carboxylic dianhydride | | | Diamine | | |
| Polyimide | polymer | Long alkylene chain | Others | | Long alkylene chain | Others | |
| Synthesis | PI-1 | — | t-2-6 (100) | — | d-1-6 (25) | d-2-8 | d-2-9 |
| Example 17 | | | | | | (55) | (20) |
| Synthesis | PI-2 | — | t-2-6 (80) | t-2-4 | d-1-7 (25) | d-2-8 | d-2-9 |
| Example 18 | | | | (20) | | (55) | (20) |
| Synthesis | PI-3 | — | t-2-6 (100) | — | — | d-2-8 | d-2-9 |
| Example 19 | | | | | | (80) | (20) |
| Synthesis | PI-4 | t-1-1 (20) | t-2-6 (80) | — | — | d-2-3 | d-2-10 |
| Example 20 | | | | | | (30) | (40) |
| Synthesis | PI-5 | t-1-3 (20) | t-2-6 (80) | — | d-1-8 (50) | d-2-3 | d-2-10 |
| Example 21 | | | | | | (10) | (10) |
| Synthesis | PI-6 | — | t-2-6 (100) | — | d-1-8 (30) | — | d-2-10 |
| Example 22 | | | | | | | (30) |
| Synthesis | PI-7 | — | t-2-6 (100) | — | — | d-2-3 | d-2-10 |
| Example 23 | | | | | | (30) | (40) |
| Synthesis | PI-8 | — | t-2-6 (50) | t-2-7 | d-1-9 (40) | d-2-8 | d-2-14 |
| Example 24 | | | | (50) | | (55) | (4) |
| Synthesis | PI-9 | — | t-2-6 (50) | t-2-7 | d-1-10 (40) | d-2-8 | d-2-14 |
| Example 25 | | | | (50) | | (55) | (4) |
| Synthesis | PI-10 | — | t-2-6 (50) | t-2-7 | d-1-11 (40) | d-2-8 | d-2-14 |
| Example 26 | | | | (50) | | (55) | (4) |
| Synthesis | PI-11 | — | t-2-8 (75) | t-2-1 | d-1-12 (40) | d-2-8 | d-2-14 |
| Example 27 | | | | (25) | | (55) | (4) |
| Synthesis | PI-12 | — | t-2-8 (75) | t-2-1 | d-1-13 (40) | d-2-8 | d-2-14 |
| Example 28 | | | | (25) | | (55) | (4) |
| Synthesis | PI-13 | — | t-2-6 (50) | t-2-7 | — | d-2-8 | d-2-14 |
| Example 29 | | | | (50) | | (95) | (4) |
| Synthesis | PI-14 | t-1-2 (10) | t-2-6 (70) | t-2-9 | — | d-2-10 | d-2-9 |
| Example 30 | | | | (20) | | (50) | (20) |
| Synthesis | PI-15 | — | t-2-6 (100) | — | — | d-2-10 | d-2-9 |
| Example 31 | | | | | | (50) | (20) |
| Synthesis | PI-16 | — | t-2-6 (90) | t-2-5 | d-1-14 (40) | d-2-8 | d-2-16 |
| Example 32 | | | | (10) | | (40) | (10) |
| Synthesis | PI-17 | — | t-2-6 (90) | t-2-5 | d-1-14 (40) | d-2-8 | d-2-16 |
| Example 33 | | | | (10) | | (40) | (10) |
| Synthesis | PI-18 | — | t-2-6 (90) | t-2-5 | — | d-2-8 | d-2-16 |
| Example 34 | | | | (10) | | (80) | (10) |

| | Monomer (mixing proportion/molar part) | | | | Pyridine | Acetic | |
|---|---|---|---|---|---|---|---|
| | Diamine | | | | (-time | anhydride | Imidization |
| Polyimide | Others | | | Monoamine | mole) | (-time mole) | ratio (%) |
| Synthesis | — | — | — | — | 1.0 | 1.0 | 60 |
| Example 17 | | | | | | | |
| Synthesis | — | — | — | — | 1.0 | 1.0 | 60 |
| Example 18 | | | | | | | |
| Synthesis | — | — | — | — | 1.0 | 1.0 | 60 |
| Example 19 | | | | | | | |
| Synthesis | d-2-11 | d-2-12 | — | — | 1.5 | 1.5 | 70 |
| Example 20 | (20) | (10) | | | | | |
| Synthesis | d-2-11 | d-2-12 | — | — | 1.5 | 1.5 | 70 |
| Example 21 | (20) | (10) | | | | | |
| Synthesis | d-2-11 | d-2-12 | d-2-13 | — | 1.5 | 1.5 | 70 |
| Example 22 | (20) | (10) | (10) | | | | |
| Synthesis | d-2-11 | d-2-12 | — | — | 1.5 | 1.5 | 70 |
| Example 23 | (20) | (10) | | | | | |
| Synthesis | — | — | — | ma-1 (1.5) | 5.0 | 4.0 | 95 |
| Example 24 | | | | | | | |
| Synthesis | — | — | — | ma-1 (1.5) | 5.0 | 4.0 | 95 |
| Example 25 | | | | | | | |
| Synthesis | — | — | — | ma-1 (1.5) | 5.0 | 4.0 | 95 |
| Example 26 | | | | | | | |
| Synthesis | — | — | — | ma-1 (1.5) | 5.0 | 4.0 | 95 |
| Example 27 | | | | | | | |
| Synthesis | — | — | — | ma-1 (1.5) | 5.0 | 4.0 | 95 |
| Example 28 | | | | | | | |
| Synthesis | — | — | — | ma-1 (1.5) | 5.0 | 4.0 | 95 |
| Example 29 | | | | | | | |
| Synthesis | d-2-15 | — | — | — | 1.5 | 1.5 | 70 |
| Example 30 | (30) | | | | | | |
| Synthesis | d-2-15 | — | — | — | 1.5 | 1.5 | 70 |
| Example 31 | (30) | | | | | | |
| Synthesis | d-2-15 | — | — | — | 2 | 2 | 80 |
| Example 32 | (10) | | | | | | |
| Synthesis | d-2-15 | — | — | — | 1.0 | 1.0 | 60 |
| Example 33 | (10) | | | | | | |
| Synthesis | d-2-15 | — | — | — | 2.0 | 2.0 | 80 |
| Example 34 | (10) | | | | | | |

*The term “ma-1” means n-stearylamine.

### Synthesis of Polyamic Ester

### Synthesis Example 35

### Synthesis of Polymer (PAE-1)

30 g of compound (t-2-10) as the tetracarboxylic dianhydride was added in 500 mL of ethanol to form a tetracarboxylic diester. The obtained precipitate was separated by filtration, washed with ethanol and then dried under a reduced pressure to obtain a tetracarboxylic diester powder. After 100 molar parts of the obtained tetracarboxylic diester were dissolved in NMP, 55 molar parts of compound (t-1-2) and 45 molar parts of p-phenylenediamine as the diamine were added therein and dissolved. After 300 molar parts of 4-(4,6-dimethoxy-1,3,5-triazin-2-yl)-4-methylmorpholinium chloride (DMT-MM, 15±2 wt % hydrate) were added in the resulting solution, a reaction was performed for 4 hours to obtain a solution containing 15 wt % of polyamic ester. A small fraction of the obtained polyamic ester solution was taken out and diluted by NMP into a solution having a polyamic ester concentration of 10 wt %, and the solution viscosity of the resulting solution was measured to be 100 mPa·s.

### Synthesis Examples 36 and 37

### Syntheses of Polymer (PAE-2) and Polymer (PAE-3)

Except that the species and amounts of the tetracarboxylic dianhydride and the diamine were changed as in Table 3 below, the same operation as described in Synthesis Example 35 was performed to prepare polymer solutions containing polymers (PAE-2) and (PAE-3), respectively.

TABLE 3

| | | Monomer (mixing proportion/molar part) | | | |
|---|---|---|---|---|---|
| | | Carboxylic | | | |
| | | dianhydride | | Diamine | |
| | Name | Long | | Long | |
| Polyamic | of | alkylene | | alkylene | |
| ester | polymer | chain | Others | chain | Others |
| Synthesis | PAE-1 | — | t-2-10 (100) | d-1-2 (55) | d-2-8 (45) |
| Example 35 | | | | | |
| Synthesis | PAE-2 | t-1-1 | t-2-10 (70) | — | d-2-8 (100) |
| Example 36 | | (30) | | | |
| Synthesis | PAE-3 | — | t-2-10 (100) | — | d-2-8 (100) |
| Example 37 | | | | | |

### Example 1

### Preparation of Liquid Crystal Alignment Agent

A solution containing polyamic acid (PAA-1) as the polymer (P) was added with NMP and butyl cellosolve (BC) and sufficiently stirred to form a solution having a solid content of 6.0 wt % and a solvent composition of NMP:BC=50:50 (weight ratio). The solution was filtered by a filter having a pore diameter of 1 μm to finish preparing a liquid crystal alignment agent (S1).

<Fabrication of TN-Type LCD Device>

An LCD device 10 as shown in FIG. 1 was fabricated as follows. First, a pair of substrates was prepared, which included an array substrate 11 with a TFT (thin-film transistor) substrate 13 containing TFTs and pixel electrodes disposed on one surface of the transparent substrate 12, and an opposite substrate 14 with an opposite electrode 16 as a transparent electrode on one surface of the transparent substrate 15. Next, the above prepared liquid crystal alignment agent (S1) was coated on the surface of the TFT substrate 13 using a liquid crystal alignment film printer made by Nissha Printing Co., Ltd., was heated (pre-baked) on a hot plate of 80° C. for 1 min to remove the solvent, and was further heated (post-baked) on a hot plate of 210° C. for 30 min to form a coating film having an average film thickness of 80 nm.

A rubbing treatment was performed on the coating film to give a liquid crystal alignment capability, using a rubbing machine having a roll of wound rayon cloth with a roll rotation speed of 500 rpm, a stage moving speed of 3 cm/s and a fur pressed-in length of 0.4 mm. Thereafter, ultrasonic cleaning was conducted in pure water for 1 min, and the coating film was dried in a clean oven of 100° C. for 10 min to obtain a substrate having a liquid crystal alignment film. The above operation was also performed on the opposite substrate 14, so as to obtain a pair of (or two) substrates having the liquid crystal alignment films 17 and 18 on transparent electrodes.

Next, on the liquid crystal alignment film of each of the above pair of substrates, an epoxy resin adhesion containing aluminum oxide balls with a diameter of 5.5 μm as a sealing material 18 was coated along a peripheral region of the substrate surface. Thereafter, the substrates were press-bonded with the surfaces of the liquid crystal alignment films facing each other, and the adhesion was cured. Next, a nematic liquid crystal (MLC-6221, produced by Merck) was filled between the pair of substrates from a liquid crystal injection hole, and then the liquid crystal injection hole was sealed with an acrylic photo-curable adhesion to finish fabricating the liquid crystal cell.

<Evaluation of Reliability>

The above fabricated liquid crystal cell was used to evaluate the reliability of LCD device. The evaluation was performed as follows. Firstly, pulses each having a voltage of 5V and a duration of 60 μs were applied to the above liquid crystal cell for 167 ms, and the voltage holding ratio (VHR1) was measured after 167 ms from the end of the application. Next, the liquid crystal cell was placed still in an oven of 80° C. for 200 hours while irradiated with a LED lamp, and then placed still at room temperature to naturally cool to room temperature. After cooling, pulses each having a voltage of 5V and a duration of 60 μs were applied to the liquid crystal cell for 167 ms, and the voltage holding ratio (VHR2) was measured after 167 ms from the end of the application. The apparatus for measurement was “VHR-1” made by Toyo Corp. The change ratio (ΔVHR) in VHR was calculated using Equation (2) below to evaluate the reliability of the LCD device.

ΔVHR(%)=(VHR1−VHR2)/VHR1×100 (2)

In the evaluation, the reliability was ranked as “very good (©)” when ΔVHR was less than 1.0%, as “good (◯)” when 1%≦ΔVHR<2.0%, as “acceptable (Δ)” when 2.0 V≦ΔVHR<2.5%, or as “bad (x)” when ΔVHR was 2.5% or more. As a result, the reliability of the product of Example 1 was ranked as “good”.

<Evaluation of Residual-Image Characteristic>

The above fabricated liquid crystal cell was driven by an AC voltage of 10 V for 30 hours, and then an apparatus including a light polarizer and a light analyzer between a light source and a light intensity detector was used to measure the minimal relative transmittance (%), which is expressed by Equation (3) below:

Minimal relative transmittance (%)=(β−B₀)/(B₁₀₀−B₀)×100 (3),

wherein B₀ is the amount of transmitted light under crossed nicols in the blank state, B₁₀₀ is the amount of transmitted light under parallel nicols in the blank state, and β is the minimal amount of transmitted light when the LCD device is between the light polarizer and the light analyzer under crossed nicols.

The black level in the dark state was represented by the minimal relative transmittance of the LCD device, and a smaller black level means a better contrast property (residual-image characteristic). The residual-image characteristic was ranked as “very good (©)” when the minimal relative transmittance was less than 0.5%, as “good (◯)” when the same was greater than or equal to 0.5% and less than 1.0%, as “acceptable (Δ)” when the same was greater than or equal to 1.0% and less than 1.5%, or as “bad (x)” when the same was 1.5% or more. As a result, the residual-image characteristic of the LCD device was ranked as “very good”.

### Examples 2 to 8 and 21 to 24, and Comparative Examples 1 to 4, 9 and 10

Except that the species and amounts of the polymer were changed as in Table 4 below, liquid crystal alignment agents (S2) to (S8), (S21) to (S24), (R1) to (R4), (R9) and (R10) were respectively prepared in the same manner of Example 1 and respectively used to fabricate liquid crystal cells in the same manner of Example 1, and the reliability and the residual-image characteristic of LCD device were evaluated. The results are shown in Table 4 below.

TABLE 4

| | | Polymer | | Evaluation | |
|---|---|---|---|---|---|
| | Alignment | | Amount | | Residual |
| | agent | Species | (weight part) | Reliability | image |
| Example 1 | S1 | PAA-1 | 100 | ◯ | © |
| Example 2 | S2 | PAA-2 | 100 | © | © |
| Example 3 | S3 | PAA-3 | 100 | © | © |
| Example 4 | S4 | PAA-4 | 100 | © | ◯ |
| Comparative | R1 | PAA-5 | 100 | X | Δ |
| Example 1 | | | | | |
| Comparative | R2 | PAA-6 | 100 | X | © |
| Example 2 | | | | | |
| Example 5 | S5 | PAA-7 | 100 | © | © |
| Example 6 | S6 | PAA-8 | 100 | © | © |
| Example 7 | S7 | PAA-9 | 100 | © | © |
| Example 8 | S8 | PAA-10 | 100 | Δ | ◯ |
| Comparative | R3 | PAA-11 | 100 | X | X |
| Example 3 | | | | | |
| Example 9 | S9 | PAA-15 | 100 | © | © |
| Comparative | R4 | PAA-16 | 100 | X | X |
| Example 4 | | | | | |
| Example 10 | S10 | PI-1 | 100 | © | © |
| Example 11 | S11 | PI-2 | 100 | © | © |
| Comparative | R5 | PI-3 | 100 | X | Δ |
| Example 5 | | | | | |
| Example 12 | S12 | PI-4 | 100 | © | © |
| Example 13 | S13 | PI-5 | 100 | © | © |
| Example 14 | S14 | PI-6 | 100 | © | © |
| Comparative | R6 | PI-7 | 100 | X | Δ |
| Example 6 | | | | | |
| Example 15 | S15 | PI-8 | 100 | © | © |
| Example 16 | S16 | PI-9 | 100 | © | © |
| Example 17 | S17 | PI-10 | 100 | © | ◯ |
| Example 18 | S18 | PI-11 | 100 | ◯ | ◯ |
| Example 19 | S19 | PI-12 | 100 | ◯ | ◯ |
| Comparative | R7 | PI-13 | 100 | X | X |
| Example 7 | | | | | |
| Example 20 | S20 | PI-14 | 100 | © | © |
| Comparative | R8 | PI-15 | 100 | X | X |
| Example 8 | | | | | |
| Example 21 | S21 | PAA-12 | 50 | © | © |
| | | PI-16 | 50 | | |
| Example 22 | S22 | PAA-13 | 40 | © | © |
| | | PI-17 | 60 | | |
| Comparative | R9 | PAA-14 | 80 | X | Δ |
| Example 9 | | PI-18 | 20 | | |
| Example 23 | S23 | PAE-1 | 100 | © | © |
| Example 24 | S24 | PAE-2 | 100 | © | © |
| Comparative | R10 | PAE-3 | 100 | Δ | X |
| Example 10 | | | | | |

In Table 4, the term “amount” in the column of polymer means the mixing proportion (weight part) of the corresponding polymer relative to 100 weight part of the total amount of the polymer component mixed in the liquid crystal alignment agent.

### Example 9

### Preparation of Liquid Crystal Alignment Agent

A solution containing polyamic acid (PAA-15) as the polymer (P) was added with NMP and butyl cellosolve (BC) and sufficiently stirred to form a solution having a solid content of 6.0 wt % and a solvent composition of NMP:BC=50:50 (weight ratio). The solution was filtered by a filter having a pore diameter of 1 μm to prepare a liquid crystal alignment agent (S9).

<Fabrication of LCD Device with Photo-Alignment Method and Evaluation of the Same>

Except that the above prepared liquid crystal alignment agent (S9) was used and a photo-alignment treatment was performed instead of the rubbing treatment, a liquid crystal cell was fabricated in the same manner of Example 1. The photo-alignment treatment was performed as follows. Firstly, the surface of the pre-baked coating film was irradiated with a polarized UV light containing a bright line of 254 nm in the normal direction of the substrate using an Hg—Xe lamp, in an irradiation dose of 700 mJ/cm², and then the coating film was heated (post-baked) in a clean oven of 230° C. for 1 hour to be given a liquid crystal alignment capability.

In this Example, the above fabricated liquid crystal cell was used to evaluate the reliability and residual-image characteristic of LCD device. As a result, the reliability and residual-image characteristic of the product of this Example were ranked as “very good”.

### Comparative Example 4

Except that the species of the used polymer was changed to polyamic acid (PAA-16), a liquid crystal alignment agent (R4) was prepared in the same way of Example 9. The prepared liquid crystal alignment agent (R4) was used to fabricate a liquid crystal cell with a photo-alignment method in the same way of Example 9, and the reliability and residual-image characteristic of LCD device were evaluated. As a result, the reliability and the residual-image characteristic of the product of this Comparative Example were ranked as “bad”.

### Example 10

### Preparation of Liquid Crystal Alignment Agent

A solution containing polyamic acid (PI-1) as the polymer (P) was added with NMP and butyl cellosolve (BC) and sufficiently stirred to form a solution having a solid content of 6.0 wt % and a solvent composition of NMP:BC=50:50 (weight ratio). The solution was filtered by a filter having a pore diameter of 1 μm to prepare a liquid crystal alignment agent (S10).

<Fabrication of Vertical-Alignment LCD Device and Evaluation of the Same>

Except that the liquid crystal alignment agent (S10) prepared in Example 10 was used, no rubbing treatment was performed and the used liquid crystal was changed to the nematic liquid crystal of MLC-6608 produced by Merck, a liquid crystal cell is fabricated in the same manner of Example 1. The fabricated liquid crystal cell was used to evaluate the reliability and residual-image characteristic of LCD device in the same manner of Example 1. As a result, the reliability and the residual-image characteristic of this Example were ranked as “very good”.

### Examples 11 to 20, and Comparative Examples 5 to 8

Except that the species and amounts of the polymer were changed as in the above Table 4, liquid crystal alignment agents (S11) to (S20) and (R5) to (R8) were respectively prepared in the same manner of Example 10 and respectively used to fabricate liquid crystal cells in the same manner of Example 10, and the reliability and the residual-image characteristic of LCD device were evaluated. The results are shown in the above Table 4.

As shown in Table 4, by using a liquid crystal alignment agent containing a polymer having the specific moiety in its main chain to form the liquid crystal alignment films, even in a case where the sealing material was coated on the surface of the liquid crystal alignment film, the reliability and residual-image characteristic of the LCD device both can be good (Examples 1 to 24). On the contrary, in the Comparative Examples, when the sealing material was coated on the surfaces of the liquid crystal alignment films to fabricate a liquid crystal cell, the reliability and the residual-image characteristic of the LCD device were “acceptable” or “bad,” which were worse than the results of the Examples.

### Example 25

Except that the liquid crystal alignment agent (S14) prepared in Example 14 and the sealing material was coated on the surface of the liquid crystal alignment film and on the surface of the array substrate, the same operation of Example 10 was performed to fabricate a liquid crystal cell as shown FIG. 2. The fabricated liquid crystal cell was used to evaluate the reliability and the residual-image characteristic in the same manner of Example 1. As a result, the reliability and residual-image characteristic of this Example were ranked as “very good.”

### Comparative Example 11

Except that the liquid crystal alignment agent (R6) prepared in Comparative Example 6 and the sealing material was coated on the surface of the liquid crystal alignment film and the surface of the array substrate, the same operation of Example 10 was performed to fabricate a liquid crystal cell as shown FIG. 2. The fabricated liquid crystal cell was used to evaluate the reliability and the residual-image characteristic in the same manner of Example 1. As a result, the reliability was ranked as “bad” and the residual-image characteristic ranked as “acceptable” in this example.

### Reference Example 1

The liquid crystal alignment agent (S14) prepared in Example 14 was coated on the surface of a glass substrate of 1 mm thick having thereon transparent electrodes including an ITO film, using a liquid crystal alignment film printer made by Nissha Printing Co., Ltd. The substrate was heated (pre-baked) on a hot plate of 80° C. for 1 min, and was further heated (post-baked) on a hot plate of 200° C. for 60 min to form a coating film having an average film thickness of 800 angstroms. The operation was repeated to obtain two glass substrates each having a liquid crystal alignment film on a transparent conductive film.

Next, on one of the above pair of substrates, an epoxy resin adhesion containing aluminum oxide balls with a diameter of 5.5 urn was coated on the region of the one substrate where the liquid crystal alignment film was not formed (on the ITO film), which was a peripheral portion of the surface of the one substrate having the liquid crystal alignment film. The pair of substrates were overlapped and press-bonded with each other with the surfaces of the liquid crystal alignment films facing each other, and then the adhesive was cured. Next, a nematic liquid crystal (MLC-6608, produced by Merck) was filled between the pair of substrates from the liquid crystal injection hole, and then the liquid crystal injection hole was sealed with an acrylic photo-curable adhesive to finish fabricating a vertical-alignment liquid crystal cell.

The fabricated liquid crystal cell was used to evaluate the reliability and residual-image characteristic of LCD device in the same manner of Example 1. As a result, the reliability and the residual-image characteristic of the product of this example were ranked as “very good”.

### Reference Example 2

Except that the liquid crystal alignment agent (R6) prepared in Comparative Example 6 was used, a liquid crystal cell was fabricated in the same manner of Reference Example 1. The fabricated liquid crystal cell was evaluated for the reliability and residual-image characteristic in the same manner of Example 1. As a result, the reliability and the residual-image characteristic of this example were also ranked as “very good”.

The results of the evaluations of the examples in which the coated position of the sealing material was different or the cell structure was different are shown in Table 5 below.

TABLE 5

| | | Polymer | | Evaluation | |
|---|---|---|---|---|---|
| | Alignment | | Amount | | Residual |
| | agent | Species | (weight part) | Reliability | image |
| Example 14 | S14 | PI-6 | 100 | © | © |
| Example 25 | S14 | PI-6 | 100 | © | © |
| Reference | S14 | PI-6 | 100 | © | © |
| Example 1 | | | | | |
| Comparative | R6 | PI-7 | 100 | X | Δ |
| Example 6 | | | | | |
| Comparative | R6 | PI-7 | 100 | X | Δ |
| Example 11 | | | | | |
| Reference | R6 | PI-7 | 100 | © | © |
| Example 2 | | | | | |

As shown in Table 5, by using a liquid crystal alignment agent containing a polymer having the specific moiety in its main chain to form a liquid crystal alignment film, in a case where the sealing material was coated on the surface of the liquid crystal alignment film, the reliability and the residual-image characteristic of the LCD device both can be good (Examples 14 and 25). On the contrary, in the Comparative Examples, when the sealing material was coated on the surface of the liquid crystal alignment film, the reliability and the residual-image characteristic of the LCD device were both worse than the results of the Examples.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. A liquid crystal display (LCD) device, comprising a pair of substrates facing each other, liquid crystal alignment films disposed on opposite surfaces of the substrates respectively, a sealing part bonded between the substrates, and a liquid crystal layer containing liquid crystal molecules that is disposed in a region defined by the substrates and the sealing part, wherein
the sealing part is disposed on surfaces of the liquid crystal alignment films, and
the liquid crystal alignment films comprise a polymer (P) having in its main chain a moiety (1) or (2), wherein
the moiety (1) is an alkylene chain having 3 or more carbon atoms, and
the moiety (2) has a structure obtained by inserting at least one group selected from the group consisting of —CO—, —O—, —NH— and —Si(R¹)₂— between carbon atoms of an alkylene chain having 3 or more carbon atoms, wherein R¹ is a monovalent hydrocarbon group having 1 to 12 carbon atoms.

2. The LCD device of claim 1, wherein the polymer (P) comprises at least one polymer selected from the group consisting of a polyamic acid, a polyamic ester and a polyimide.

3. The LCD device of claim 1, wherein the polymer (P) is obtained through polymerization of a composition of monomers containing a compound having the moiety, and a proportion of the compound having the moiety is 1 to 70 mol % based on a total amount of the monomers used in the polymerization.

4. The LCD device of claim 1, wherein the alkylene chain in the moiety (1) or (2) has 3 to 12 more carbon atoms.

5. The LCD device of claim 1, wherein the moiety has a structure obtained by inserting —CO—, —O— or —COO— between carbon atoms of an alkylene chain having 3 or more carbon atoms.

6. A method for fabricating a liquid crystal display (LCD) device, comprising:
coating surfaces of respective substrates of a pair of substrates with a polymer composition that contains a polymer (P) having in its main chain a moiety (1) or (2) to form coated films;
coating a surface of the coated film on at least one of the substrates with a sealing material;
arranging the pair of substrates such that the coated films face each other as being separated by the sealing material to construct a liquid crystal cell,
wherein
the moiety (1) is an alkylene chain having 3 or more carbon atoms, and
the moiety (2) has a structure obtained by inserting at least one group selected from the group consisting of —CO—, —O—, —NH— and —Si(R¹)₂— between carbon atoms of an alkylene chain having 3 or more carbon atoms, wherein R¹ is a monovalent hydrocarbon group having 1 to 12 carbon atoms.
